(19) United States
(12) Patent Application Publication
(10) Pub. No.: US 2013/0078012 A1
(43) Pub. Date: Mar. 28, 2013

(54) IMAGE FORMING APPARATUS

(71) Applicants: Masahiro SATO, Kanagawa (JP); Atsuyuki KITAMURA, Kanagawa (JP); Atsushi OGIHARA, Kanagawa (JP); Tetsuji OKAMOTO, Kanagawa (JP); Koichi WATANABE, Kanagawa (JP); Wataru SUZUKI, Kanagawa (JP); Shuichi NISHIDE, Kanagawa (JP)

(72) Inventors: Masahiro SATO, Kanagawa (JP); Atsuyuki KITAMURA, Kanagawa (JP); Atsushi OGIHARA, Kanagawa (JP); Tetsuji OKAMOTO, Kanagawa (JP); Koichi WATANABE, Kanagawa (JP); Wataru SUZUKI, Kanagawa (JP); Shuichi NISHIDE, Kanagawa (JP)

(73) Assignee: FUJI XEROX CO., LTD., Tokyo (JP)

(21) Appl. No.: 13/407,145

(22) Filed: Feb. 28, 2012

(30) Foreign Application Priority Data
Sep. 26, 2011 (JP) 2011-209875

(51) Int. Cl. G03G 15/01

(52) U.S. Cl. 399/304

(57) ABSTRACT

An image forming apparatus includes an image carrier, a transfer member, a gripper that grips a leading end portion of a recording medium, and a restraining portion that is disposed so as to face an outer peripheral surface of the transfer member and that is movable relative to the transfer member. The restraining member restrains a trailing end portion of the recording medium that is gripped by the gripper from rising. The restraining portion has widths in a rotational axis direction of the transfer member and in a transport direction of the recording medium and is capable of facing the recording medium in a faceable region, and a part of the faceable region over which the restraining portion faces the trailing end portion of the recording medium is larger than a part of the faceable region over which the restraining member does not face the trailing end portion.

### CROSS-REFERENCE TO RELATED APPLICATIONS

This application is based on and claims priority under 35 USC 119 from Japanese Patent Application No. 2011-209875 filed Sep. 26, 2011.

### BACKGROUND

### Technical Field

The present invention relates to an image forming apparatus.

### Summary

According to an aspect of the invention, an image forming apparatus includes an image carrier that is rotatably disposed and that carries an image on an outer peripheral surface thereof; a transfer member that is rotatably disposed such that an outer peripheral surface thereof faces the outer peripheral surface of the image carrier, the transfer member transferring the image carried on the image carrier to a recording medium in a transfer region that is formed by the transfer member and the image carrier; a gripper that rotates in synchronism with the transfer member, the gripper gripping a leading end portion, in a transport direction, of the recording medium that is transported toward the transfer region; and a restraining portion that is disposed so as to face the outer peripheral surface of the transfer member and that is movable relative to the transfer member, the restraining member restraining a trailing end portion, in the transport direction, of the recording medium that is gripped by the gripper from rising. The restraining portion has a width in a rotational axis direction of the transfer member and a width in the transport direction of the recording medium and is capable of facing the recording medium in a faceable region, and a part of the faceable region over which the restraining portion faces the trailing end portion, in the transport direction, of the recording medium is larger than a part of the faceable region over which the restraining member does not face the trailing end portion, in the transport direction, of the recording medium.

### BRIEF DESCRIPTION OF THE DRAWINGS

Exemplary embodiment(s) of the present invention will be described in detail based on the following figures, wherein:

FIG. 1 is a schematic view of an image forming apparatus according to an exemplary embodiment of the present invention;

FIG. 2 is an enlarged view of a transfer region;

FIGS. 3A and 3B are schematic views of a mechanism for rotating a photoconductor drum and a transfer drum;

FIGS. 4A and 4B are schematic views of a leading end gripper and a trailing end gripper;

FIGS. 5A and 5B are schematic sectional views of the leading end gripper taken along a plane perpendicular to the rotational axis direction;

FIGS. 6A to 6D are schematic views illustrating an operation with which a sheet that has been wound around the transfer drum is separated from the transfer drum;

FIG. 7 is a schematic view of the trailing end gripper;

FIG. 8A is a sectional view taken along line VIIIA-VIIIA of FIG. 7, and FIG. 8B is a sectional view illustrating another state;

FIG. 9 is a functional block diagram of a controller;

FIGS. 10A and 10B illustrate a flowchart of a transfer process performed by the controller;

FIG. 11 is a timing chart of an image forming operation;

FIGS. 12A to 12D illustrate an operation with which a sheet is wound around the transfer drum;

FIG. 13 is a timing chart illustrating timings with which an error between a set sheet length and the length of an actually transported sheet is obtained and then forming of a toner image on the photoconductor drum is stopped;

FIG. 14A is a schematic view illustrating the relative positions of a trailing end portion of a sheet in the transport direction and a sheet restraining portion of the trailing end gripper, and FIG. 14B is a sectional view taken along line XIVB-XIVB of FIG. 14A;

FIGS. 15A and 15B illustrate an example of a fault that may occur if a part a region of the sheet restraining portion that is faceable with a sheet and that is facing the trailing end portion of a sheet is smaller than a part of the region that is not facing the tailing end portion of the sheet; and

FIGS. 16A to 16C are schematic sectional views of a sheet restraining portion according to another embodiment.

### DETAILED DESCRIPTION

Hereinafter, an exemplary embodiment will be described in detail with reference to the drawings.

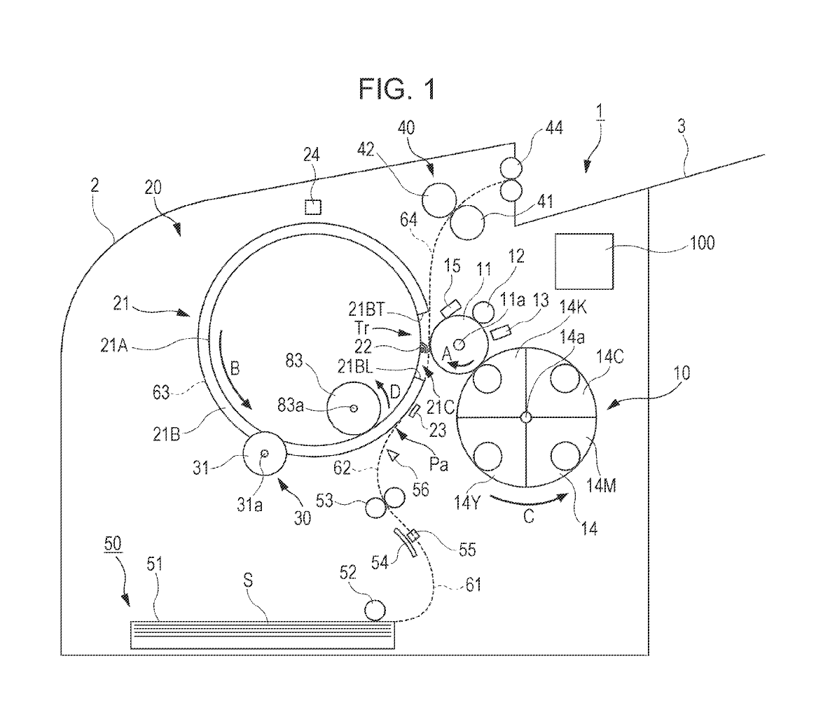

FIG. 1 is a schematic view of an image forming apparatus 1 according to the exemplary embodiment.

The image forming apparatus 1 includes an image forming section 10, a transfer section 20, a fixing section 40, and a sheet feeding section 50. The image forming section 10 forms a toner image. The transfer section 20 transfers the toner image, which has been formed by the image forming section 10, to a sheet S, which is an example of a recording medium. The fixing section 40 fixes the toner image, which has been transferred to the sheet S by the transfer section 20, to the sheet S. The sheet feeding section 50 supplies the sheet S, on which the toner image is to be transferred, to the transfer section 20. The image forming apparatus 1 further includes a controller 100 that controls operations of the image forming section 10, the transfer section 20, the fixing section 40, the sheet feeding section 50, and the like. These sections of the image forming apparatus 1 are disposed in a housing 2. A sheet stacker 3, on which sheets S that have been output from the fixing section 40 are stacked, is disposed on an upper part of the housing 2.

First, the image forming section 10 will be described.

The image forming section 10 includes a photoconductor drum 11, a charger 12, an exposure device 13, a rotary developing device 14, and a cleaner 15. The charger 12 charges the photoconductor drum 11. The exposure device 13 exposes the charged photoconductor drum 11 to light and thereby forms an electrostatic latent image on the photoconductor drum 11. The rotary developing device 14 develops the electrostatic latent image with toner. The cleaner 15 removes residual toner and the like that remain on the photoconductor drum 11 after the developed toner image has been transferred.

The photoconductor drum 11 is disposed so as to be rotatable around a rotary shaft 11a in the direction of arrow A. The photoconductor drum 11 has a surface (outer peripheral surface) on which a photosensitive layer (not shown) is formed and carries an image on the outer peripheral surface. The photoconductor drum 11 is an example of an image carrier. The charger 12, the exposure device 13, the rotary developing device 14, and the cleaner 15 are arranged around the photoconductor drum 11 in this order in the direction of arrow A. The outside diameter of the photoconductor drum 11 is, for example, 30 mm.

In the present exemplary embodiment, the charger 12 is a contact roller charger that charges the photoconductor drum 11 while rotating together with the photoconductor drum 11.

The exposure device 13 forms an electrostatic latent image by selectively irradiating the surface of the charged photoconductor drum 11 with light. The exposure device 13 according to the present exemplary embodiment includes plural light-emitting elements (for example, LEDs) that are arranged in the axial direction of the rotary shaft 11a of the photoconductor drum 11.

The rotary developing device 14 includes a rotary shaft 14a and developing units 14Y, 14M, 14C, and 14K for yellow (Y), magenta (M), cyan (C), and black (K). The rotary shaft 14a extends in the axial direction of the rotary shaft 11a of the photoconductor drum 11. The developing units 14Y, 14M, 14C, and 14K are disposed around the rotary shaft 14a. The rotary developing device 14 rotates around the rotary shaft 14a in the direction of arrow C. One of the developing units of the rotary developing device 14 stops at a position (hereinafter referred to as developing position) at which the developing unit faces the photoconductor drum 11. The rotary developing device 14 develops the electrostatic latent image, which has been formed on the photoconductor drum 11 by the exposure device 13, by using toner of the developing unit that has stopped at the developing position. The outside diameter of the rotary developing device 14 is, for example, 100 mm.

The cleaner 15 removes toner and other adherents that remain on the surface of the photoconductor drum 11. In the present exemplary embodiment, the cleaner 15 is a blade-type cleaner.

Next, the transfer section 20 will be described.

The transfer section 20 includes a transfer drum 21, a leading end gripper 22, a trailing end gripper 23, and a phase sensor 24. The transfer drum 21, which is an example of a transfer member, faces the photoconductor drum 11 and extends in the axial direction of the rotary shaft 11a of the photoconductor drum 11. The leading end gripper 22 grips a leading end portion, in the transport direction, of the sheet S at a position near an outer peripheral surface of the transfer drum 21. The trailing end gripper 23 restrains a trailing end portion of the sheet S in the transport direction from rising from the outer peripheral surface of the transfer drum 21. The phase sensor 24 measures the phase of the transfer drum 21 that rotates.

The transfer drum 21 includes a base member 21A having a cylindrical shape and an elastic layer 21B formed on the outer peripheral surface of the base member 21A. The base member 21A is a conductive drum made of, for example, a metal. The elastic layer 21B is a semiconductive elastic member including a foam layer. The elastic layer 21B is made of, for example, a resin such as a polyurethane resin containing a conductive material. With respect to the circumferential direction, the elastic layer 21B covers the outer peripheral surface of the base member 21A excluding a part of the outer peripheral surface extending along the axis of the base member 21A. That is, the elastic layer 21B has a C-shaped cross section. The part of the outer peripheral surface of the base member 21A of the transfer drum 21 that is not covered by the elastic layer 21B is an exposed portion 21C at which the base member 21A is exposed. The length of the elastic layer 21B in the circumferential direction is larger than the length of the largest sheet S that is usable in the image forming apparatus 1.

The transfer drum 21 is configured to rotate in the direction of arrow B. At a facing position at which the transfer drum 21 faces the photoconductor drum 11, this direction is the same as the direction in which the photoconductor drum 11 rotates (the direction of arrow A). The outside diameter of the transfer drum 21 is, for example, 120 mm. Thus, in the present exemplary embodiment, the outside diameter of the transfer drum 21 is larger than that of the photoconductor drum 11.

A transfer bias having a polarity opposite to that of toner is applied to the base member 21A of the transfer drum 21 by a high-voltage power supply (not shown). The photoconductor drum 11 is grounded. As a result, in the transfer region Tr, toner that forms a toner image on the photoconductor drum 11 is transferred to the sheet S on the elastic layer 21B.

Hereinafter, a position at which the photoconductor drum 11 faces the transfer drum 21 will be referred to as a transfer position. At the transfer position, a transfer region Tr is formed by the photosensitive layer of the photoconductor drum 11 and the elastic layer 21B of the transfer drum 21 that are in contact with each other. In other words, the transfer region Tr is a region in which a toner image on the photoconductor drum 11 is transferred to the sheet S on the elastic layer 21B and in which the elastic layer 21B (or the sheet S on the elastic layer 21B) and the photoconductor drum 11 are in contact with each other.

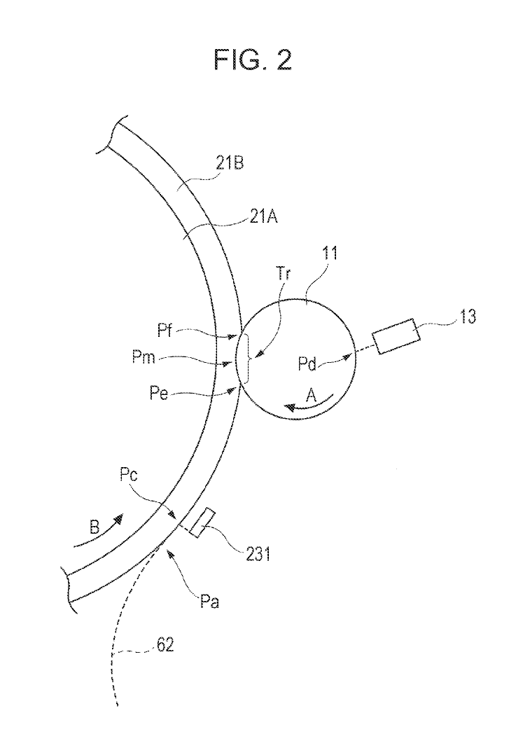

FIG. 2 is an enlarged view of the transfer region Tr.

As illustrated in FIG. 2, the transfer region Tr extends from a contact start point Pe to a contact end point Pf via a maximum compression point Pm. That is, as the transfer drum 21 rotates, a specific point on the elastic layer 21B of the transfer drum 21 starts contacting the photoconductor drum 11 at the contact start point Pe and finishes contacting the photoconductor drum 11 at the contact end point Pf. When the specific point is at the maximum compression point Pm, the elastic layer 21B is compressed by the photoconductor drum 11 to have the smallest thickness.

As illustrated in FIG. 2, the photoconductor drum 11 is exposed to light by the exposure device 13 at a position Pd.

The leading end gripper 22 and the trailing end gripper 23 will be described below in detail.

The phase sensor 24 is disposed so as to face the outer peripheral surface of the transfer drum 21. The phase sensor 24 measures the phase of the transfer drum 21 by detecting a mark (not shown) formed on the outer peripheral surface of the transfer drum 21. Alternatively, the phase sensor 24 may be disposed so as to measure the phase of the transfer drum 21 by detecting a mark formed on the inner peripheral surface of the transfer drum 21.

In the present exemplary embodiment, the transfer drum 21, the leading end gripper 22, the trailing end gripper 23, and the phase sensor 24 are integrated with each other to form the transfer section 20 as a unit (transfer unit). The transfer unit is removable from the housing 2 of the image forming apparatus 1.

Next, a mechanism for rotating the photoconductor drum 11 and the transfer drum 21 will be described.

As illustrated in FIG. 1, the image forming apparatus 1 according to the present exemplary embodiment includes a transfer drum supporter 30. The transfer drum supporter 30 rotatably supports the transfer drum 21 at a position that is upstream of the transfer region Tr, in which the photoconductor drum 11 and the transfer drum 21 face each other, in the rotation direction of the transfer drum 21 and that is outside the transfer drum 21. The transfer drum supporter 30 is disposed so as to be in contact with the outer peripheral surface of the base member 21A of the transfer drum 21. The transfer drum supporter 30 includes transfer drum support rollers 31 that rotate around a rotary shaft 31a. The transfer drum support rollers 31 rotate as the transfer drum 21 rotates in the direction of arrow B.

The image forming apparatus 1 according to the present exemplary embodiment further includes a transfer drum driving roller 83. With respect to the direction of arrow B, the transfer drum driving roller 83 is disposed at a position that is upstream of the transfer region Tr in the direction of arrow B and that is downstream of the position at which the transfer drum 21 and the transfer drum support rollers 31 are in contact with each other. The transfer drum driving roller 83 rotatably supports the transfer drum 21 and transmits a force that rotates the transfer drum 21 in the direction of arrow B. The transfer drum driving roller 83 is rotated around a rotary shaft 83a in the direction of arrow D and thereby rotates the transfer drum 21 in the direction of arrow B. Hereinafter, the axial direction of the rotary shaft 83a, which serves as the rotation axis of the transfer drum driving roller 83, will be referred to as the “rotational axis direction”.

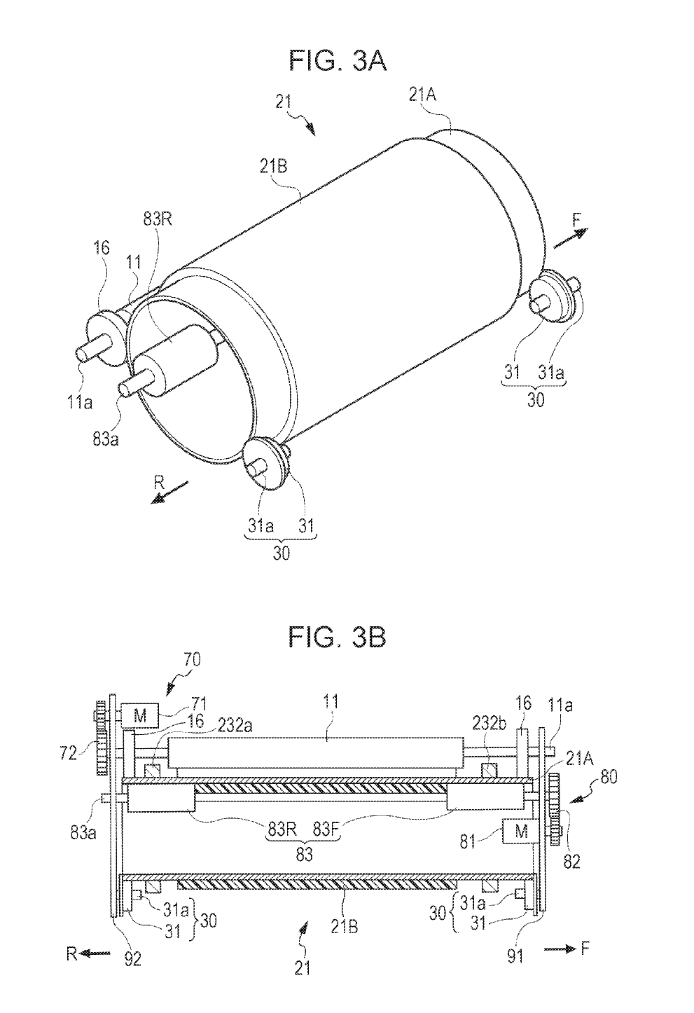

FIGS. 3A and 3B schematically illustrate a mechanism for rotating the photoconductor drum 11 and the transfer drum 21. FIG. 3A is a perspective view and FIG. 3B is a sectional view. The leading end gripper 22 and the trailing end gripper 23 are omitted from FIGS. 3A and 3B.

As illustrated in FIG. 3B, a front frame 91 and a rear frame 92 are disposed outside the ends of the photoconductor drum 11, the transfer drum 21, the transfer drum support rollers 31, and the transfer drum driving roller 83 in the rotational axis direction. The front frame 91 is disposed on the front side (indicated by arrow “F” in FIGS. 3A and 3B) of the image forming apparatus 1 illustrated in FIG. 1. The rear frame 92 is disposed on the rear side (indicated by arrow “R” in FIGS. 3A and 3B) of the image forming apparatus 1. The front frame 91 and the rear frame 92 are omitted from FIG. 3A.

The rotary shaft 11a of the photoconductor drum 11 is rotatably attached to the front frame 91 and the rear frame 92 so as to extend through the front and rear frames 91 and 92. A pair of photoconductor drum support rollers 16 are attached to the rotary shaft 11a of the photoconductor drum 11 at positions that are outside the ends of the photoconductor drum 11 and inside the front and rear frames 91 and 92 in the rotational axis direction. The pair of photoconductor drum support rollers 16 have the same diameter that is larger than that of the photoconductor drum 11. The photoconductor drum support rollers 16 are rotatably attached to the rotary shaft 11a such that its movement in the rotational axis direction is restricted.

The image forming apparatus 1 according to the present exemplary embodiment further includes a photoconductor driving device 70 that is disposed in a rear part of the image forming apparatus 1 and that rotates the photoconductor drum 11. The photoconductor driving device 70 includes a photoconductor driving motor 71, which serves as a driving source, and a photoconductor driving gear train 72 that transmits a driving force of the photoconductor driving motor 71 to the photoconductor drum 11. The photoconductor driving motor 71 is disposed in front of the rear frame 92. The drive shaft of the photoconductor driving motor 71 extends through the rear frame 92 and protrudes backward beyond the rear frame 92. The photoconductor driving gear train 72 is disposed at the back of the rear frame 92. The photoconductor driving gear train 72 connects the drive shaft of the photoconductor driving motor 71 to the rotary shaft 11a of the photoconductor drum 11 and thereby transmits a driving force from the photoconductor driving motor 71 to the photoconductor drum 11.

The image forming apparatus 1 according to the present exemplary embodiment includes a transfer driving device 80 that includes the transfer drum driving roller 83 described above and that rotates the transfer drum 21. The transfer driving device 80 includes a transfer driving motor 81, a transfer driving gear train 82, and the transfer drum driving roller 83. The transfer driving gear train 82 transmits a driving force of the transfer driving motor 81 to the transfer drum driving roller 83.

The transfer drum driving roller 83 includes two rollers, i.e. a first transfer driving roller 83F and a second transfer driving roller 83R, and the rotary shaft 83a. The rotary shaft 83a supports the first transfer driving roller 83F and the second transfer driving roller 83R and is rotatably supported by the front frame 91 and the rear frame 92. The first transfer driving roller 83F is disposed inside the front frame 91, and the second transfer driving roller 83R is disposed inside the rear frame 92 in the rotational axis direction. The distance between the first transfer driving roller 83F and the second transfer driving roller 83R in the rotational axis direction is larger than the length of an outer member 221 of the leading end gripper 22 and the length of an inner member 222, which will be described below in detail. Thus, even if a component of the leading end gripper 22 protrudes into the base member 21A as the leading end gripper 22 is opened and closed, the component does not collide with the transfer drum driving roller 83.

The outer peripheral surface of the transfer drum driving roller 83, which is a surface of contact with the transfer drum 21, is made of, for example, a polyurethane rubber or the like. The rotary shaft 83a of the transfer drum driving roller 83 is rotatably attached to the front frame 91 and the rear frame 92 so as to extend through the front and rear frames 91 and 92. A spring (not shown) for pressing the transfer drum driving roller 83 against the inner peripheral surface of the transfer drum 21 is attached to the rotary shaft 83a of the transfer drum driving roller 83. The rotary shaft 83a of the transfer drum driving roller 83 is attached to the frames 91 and 92 so that the rotary shaft 83a may be moved by a force of the spring member.

The transfer driving motor 81 of the transfer driving device 80 is disposed between the front frame 91 and the rear frame 92. The drive shaft of the transfer driving motor 81 extends through the front frame 91 and protrudes forward beyond the front frame 91. In particular, in the present exemplary embodiment, the transfer driving motor 81 is disposed so that the transfer driving motor 81 is positioned inside an opening in the transfer drum 21 in the rotational axis direction. The transfer driving gear train 82 is disposed in front of the front frame 91. The transfer driving gear train 82 connects the drive shaft of the transfer driving motor 81 to the rotary shaft 83a of the transfer drum driving roller 83 through gears, and thereby transmits a driving force from the transfer driving motor 81 to the transfer drum driving roller 83.

One of the transfer drum support rollers 31 of the transfer drum supporter 30 is disposed at the back of the front frame 91 and the other transfer drum support roller 31 is disposed in front of the rear frame 92. The rotary shaft 31a of the transfer drum support roller 31 that is disposed on the front side is rotatably attached to the front frame 91. The rotary shaft 31a of the transfer drum support roller 31 that is disposed on the rear side is rotatably attached to the rear frame 92.

Each of the transfer drum support rollers 31 is a flanged roller that is formed by integrating a pair of rollers having different diameters. The larger-diameter portion of the transfer drum support roller 31 on the front side is disposed so as to face the front frame 91, and the smaller-diameter portion of the transfer drum support roller 31 is disposed so as to face the rear frame 92. The larger-diameter portion of the transfer drum support roller 31 on the rear side is disposed so as to face the rear frame 92, and the smaller-diameter portion of the transfer drum support roller 31 is disposed so as to face the front frame 91. The smaller-diameter portion of each of the transfer drum support rollers 31 is formed from, for example, a metal, a ball bearing, or a low-friction resin (a polyacetal (POM) or the like). The larger-diameter portion is formed from, for example, a metal. In the present exemplary embodiment, a high-voltage power supply (not shown) is connected to the transfer drum support rollers 31 and a transfer bias is supplied to the base member 21A of the transfer drum 21 through the larger-diameter portions the transfer drum support rollers 31, which are made of a metal.

In contrast, the transfer drum 21 is disposed between the front and rear frames 91 and 92 in such a way that the transfer drum 21 is not in direct contact with the front and rear frames 92. The elastic layer 21B covers the outer peripheral surface of the base member 21A of the transfer drum 21 excluding both end portions of the base member 21A in the axial direction. Therefore, not only the exposed portion 21C of the transfer drum 21 illustrated in FIG. 1 but also the both end portions of the base member 21A in the axial direction are exposed to the outside.

The photoconductor drum 11 is in contact with the elastic layer 21B of the transfer drum 21 along the rotational axis direction. The pair of photoconductor drum support rollers 16, which are disposed outside the both end portions of the photoconductor drum 11, are in contact with the base member 21A of the transfer drum 21 at both end portions of the transfer drum 21 in the rotational axis direction. Thus, the photoconductor drum 11 and the photoconductor drum support rollers 16 are in contact with the outer peripheral surface of the transfer drum 21.

Moreover, the pair of transfer drum support rollers 31 are in contact with the outer peripheral surface and the side surfaces of the base member 21A of the transfer drum 21 at both ends of the transfer drum 21 in the rotational axis direction. The smaller-diameter portions of the transfer drum support rollers 31 (made of a polyurethane rubber) are in contact with the outer peripheral surface of the base member 21A. The larger-diameter portions of the transfer drum support rollers 31 (made of metal) are in contact with the side surfaces of the base member 21A. A spring (not shown) is attached to one of the pair of transfer drum support rollers 31 that is disposed on the front side, and this transfer drum support roller 31 is pushed rearward by the spring.

With the structure described above, the transfer drum 21 is indirectly and rotatably supported by the front frame 91 and the rear frame 92 through the photoconductor drum 11, the transfer drum support roller 31, and the transfer drum driving roller 83. Because the transfer drum 21 is supported by the pair of flanged transfer drum support rollers 31, displacement of the transfer drum 21 in the direction of arrow B (see FIG. 1) while the transfer drum 21 rotates is restrained.

Next, the leading end gripper 22 and the trailing end gripper 23 will be described.

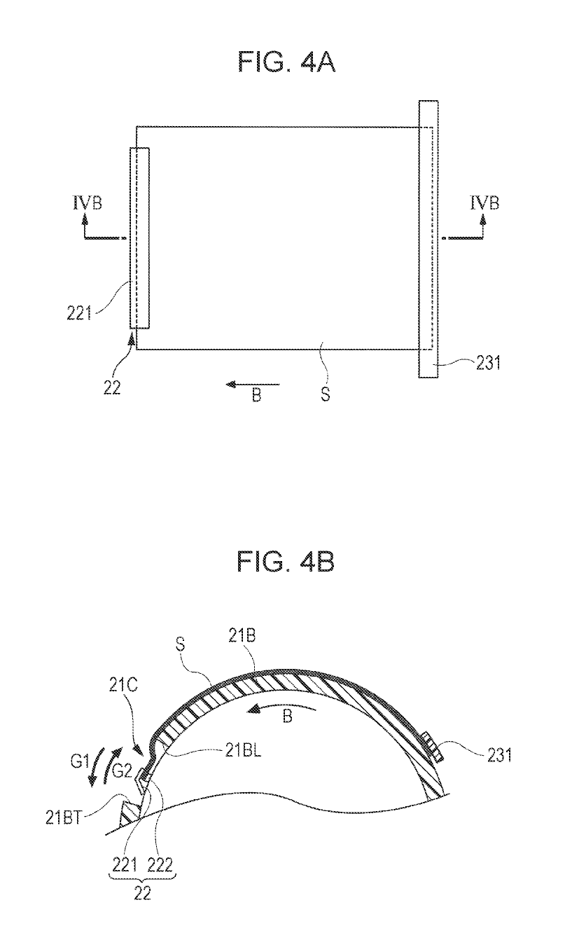

FIGS. 4A and 4B are schematic views of the leading end gripper 22 and the trailing end gripper 23.

The transfer section 20 includes the leading end gripper 22 and the trailing end gripper 23. The leading end gripper 22 grips a leading end portion of the sheet S (the left end portion of the sheet S in FIGS. 4A and 4B) on the outer peripheral surface of the transfer drum 21 in the transport direction (direction of arrow B, in which the transfer drum 21 rotates). The trailing end gripper 23 restrains a trailing end portion (the right end of the sheet S in FIG. 4), in the transport direction (direction of arrow B), of the sheet S from rising. The leading end gripper 22 and the trailing end gripper 23 rotate together with the transfer drum 21 in a state in which the leading end gripper 22 grips the leading end portion of the sheet S and the trailing end gripper 23 restrains the trailing end portion of the sheet S from rising.

The leading end gripper 22 and the trailing end gripper 23 will be described below.

First, the structure of the leading end gripper 22 will be described.

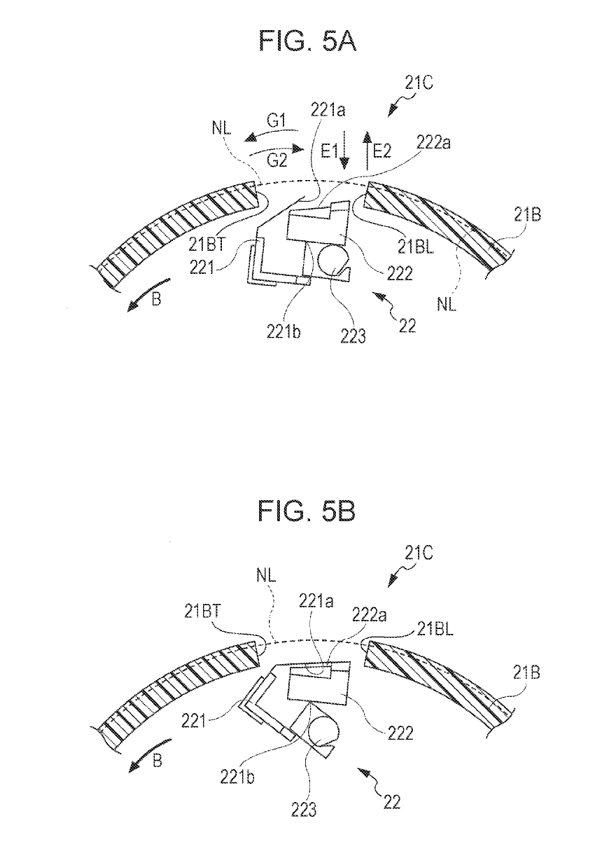

FIGS. 5A and 5B are schematic sectional views of the leading end gripper 22 taken along a plane perpendicular to the rotational axis direction. FIG. 5A illustrates a state in which the leading end gripper 22 is open, and FIG. 5B illustrates a state in which the leading end gripper 22 is closed.

As illustrated in FIGS. 5A and 5B, the leading end gripper 22 includes the outer member 221, the inner member 222, and a rotary shaft 223. The outer member 221 presses the sheet S from the outer side of the transfer drum 21 (from the upper side in FIGS. 5A and 5B). The inner member 222 presses the sheet S from the inner side of the transfer drum 21 (from the lower side in FIGS. 5A and 5B). The rotary shaft 223 is integrated with the outer member 221 and is rotatably supported by the transfer drum 21.

The outer member 221 is a plate-shaped member extending along the rotational axis direction and includes an outer pressing portion 221a and a corner portion 221b. The outer pressing portion 221a presses a side of the sheet S on which an image is formed (transferred) from the outer side of the transfer drum 21. The corner portion 221b presses the inner member 222 as the outer member 221 rotates around the rotary shaft 223. The outer pressing portion 221a is disposed closer to the outer periphery of the transfer drum 21 than the inner member 222 is. The corner portion 221b is disposed farther from the outer periphery of the transfer drum 21 than the inner member 222 is. The outer pressing portion 221a is rotatable around the rotary shaft 223 in a region closer to the outer periphery of the transfer drum 21 than the rotary shaft 223 is (in directions indicated by arrows G1 and G2 in FIG. 5A). The outer member 221 is made of a metal such as a stainless steel (SUS) and has a size such that the outer member 221 does not come into contact with the photoconductor drum 11 in the transfer region Tr.

The inner member 222 is a plate-shaped member extending in the rotational axis direction. The inner member 222 includes an inner pressing portion 222a that presses a side of the sheet S opposite to the side on which an image is formed from the inner side of the transfer drum 21. The inner member 222 is supported by the transfer drum 21 so as to be movable along a guide member (not shown) in directions inward and outward of the transfer drum 21 (as indicated by arrows E1 and E2 in FIG. 5A).

The rotary shaft 223 is disposed at a position that is inside the transfer drum 21 and near the outer periphery of the transfer drum 21 so as to extend in the rotational axis direction.

The outer member 221, the inner member 222, and the rotary shaft 223 of the leading end gripper 22 are attached to the exposed portion 21C of the transfer drum 21. To be specific, the leading end gripper 22 is disposed between a first end 21BT and a second end 21BL in the circumferential direction of the elastic layer 21B having a C-shape cross section. The relative positions of the outer member 221 and the inner member 222 change when the outer member 221 rotates around the rotary shaft 223, which is rotatably supported by the transfer drum 21 between the first end 21BT and the second end 21BL. Hereinafter, as illustrated in FIG. 5B, a state in which the outer pressing portion 221a of the outer member 221 and the inner pressing portion 222a of the inner member 222 are substantially parallel to each other and are close to each other will be referred to as a closed state of the leading end gripper 22. As illustrated in FIG. 5A, a state in which the outer pressing portion 221a of the outer member 221 and the inner pressing portion 222a of the inner member 222 are separated from each other as compared with the closed state illustrated in FIG. 5B will be referred to as an open state of the leading end gripper 22.

When the leading end gripper 22 having the structure describe above is in the open state, the outer member 221 of the leading end gripper 22 is disposed on the leading end side of a sheet S in the transport direction (the left side in FIG. 5A) and the inner member 222 of the leading end gripper 22 is disposed on the inner side of the transfer drum 21 (the lower side in FIG. 5A). In this state, as illustrated in FIG. 5A, the leading end gripper 22 is open in a direction such that the leading end gripper 22 is capable of receiving a sheet S, which has been fed from the sheet feeding section 50, in a space between the outer pressing portion 221a of the outer member 221 and the inner pressing portion 222a of the inner member 222.

When the leading end of the sheet S in the transport direction reaches a sheet feeding position Pa, which will be described below, the outer member 221 rotates around the rotary shaft 223 in a direction opposite to the transport direction of the sheet S (indicated by arrow G2 in FIG. 5A). Moreover, the corner portion 221b of the outer member 221 moves toward the outer periphery of the transfer drum 21 as the outer member 221 rotates. Due to the movement of the corner portion 221b, the inner member 222, which has been in contact with the corner portion 221b, is pushed toward the outer periphery of the transfer drum 21 along the guide member (not shown). As a result, the inner member 222 moves toward the outer periphery of the transfer drum 21 (in a direction of arrow E2 in FIG. 5A).

Thus, as illustrated in FIG. 5B, the gap between the outer pressing portion 221a and the inner pressing portion 222a becomes narrower, and thereby the sheet S is nipped between the outer and inner pressing portions 221a and 222a.

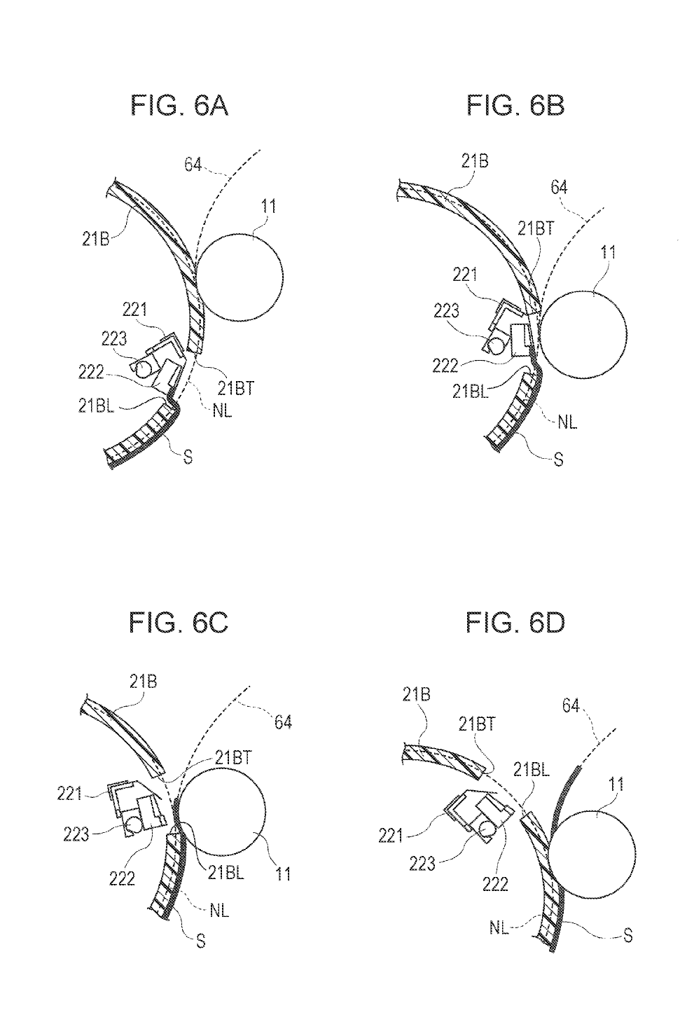

FIGS. 6A to 6D are schematic views illustrating an operation with which a sheet S that has been wound around the transfer drum 21 is released from the transfer drum 21.

An operation with which the leading end gripper 22 releases the sheet S is the opposite of the operation described above, with which the leading end gripper 22 grips the sheet S. Therefore, description of the details of the releasing operation will be omitted here, and only the difference between the releasing operation and the gripping operation will be described. The leading end gripper 22 starts releasing the sheet S after the leading end of the sheet S in the transport direction has entered the transfer region Tr. That is, after the leading end of the sheet S in the transport direction has passed the contact start point Pe (see FIG. 2), the leading end gripper 22 becomes open and starts releasing the sheet S.

After the leading end of the sheet S in the transport direction has passed the contact start point Pe, the second end 21BL of the elastic layer 21B in the circumferential direction enters the transfer region Tr (see FIG. 6C). That is, the second end 21BL passes the contact start point Pe (see FIG. 2). At this time, the leading end of the sheet S in the transport direction becomes separated from the transfer drum 21 by being nipped between the elastic layer 21B and the photoconductor drum 11. To be specific, the leading end of the sheet S in the transport direction becomes separated from the transfer drum 21 due to the rigidity of the sheet S. Then, the leading end of the sheet S in the transport direction is output to a sheet output path 64 (see FIG. 6D) and to the fixing section 40.

Here, the leading end gripper 22 does not come into contact with the photoconductor drum 11 in the closed state, in the open state, and in an intermediate state between the closed state and the open state (when the leading end gripper is being opened). The reason for this is as follows.

As a precondition, the elastic layer 21B of the transfer drum 21 is pressed by the photoconductor drum 11 by coming into contact with the photoconductor drum 11 in the transfer region Tr. In FIGS. 5A to 6D, a compressed peripheral line NL represents a cross-section of the outer peripheral surface of the transfer drum 21 that has been compressed. For ease of understanding, the compressed peripheral line NL is illustrated around the entire periphery of the transfer drum 21.

Under this precondition, as long as the leading end gripper 22 does not move beyond the compressed peripheral line NL toward the outer periphery of the transfer drum 21, the leading end gripper 22 does not come into contact with the photoconductor drum 11. In the present exemplary embodiment, as illustrated in FIGS. 5A to 6D, the components of the leading end gripper 22 (the outer member 221, the inner member 222, etc.) are disposed more inward than the compressed peripheral line NL regardless of whether the leading end gripper 22 is in the closed state, in the open state, or in the intermediate state between the closed state and the open state. Thus, the leading end gripper 22 does not come into contact with the photoconductor drum 11.

However, the outer member 221 may be disposed more outward than the compressed peripheral line NL when the leading end gripper 22 is in the open state and/or the leading end gripper 22 is in the intermediate state between the closed state and the open state. In this case, the timing with which the state of the leading end gripper 22 is started to be changed from the closed state to the open state may be determined so that the outer member 221 does not come into contact with the photoconductor drum 11. For example, the state of the leading end gripper 22 may be started to be changed from the closed state to the open state after the leading end of the sheet S in the transport direction, which is gripped by the leading end gripper 22, has passed the transfer region Tr or after the outer member 221 has passed a position nearest to the photoconductor drum (which is, imaginarily, the maximum compression point Pm).

Next, the structure of the trailing end gripper 23 will be described.

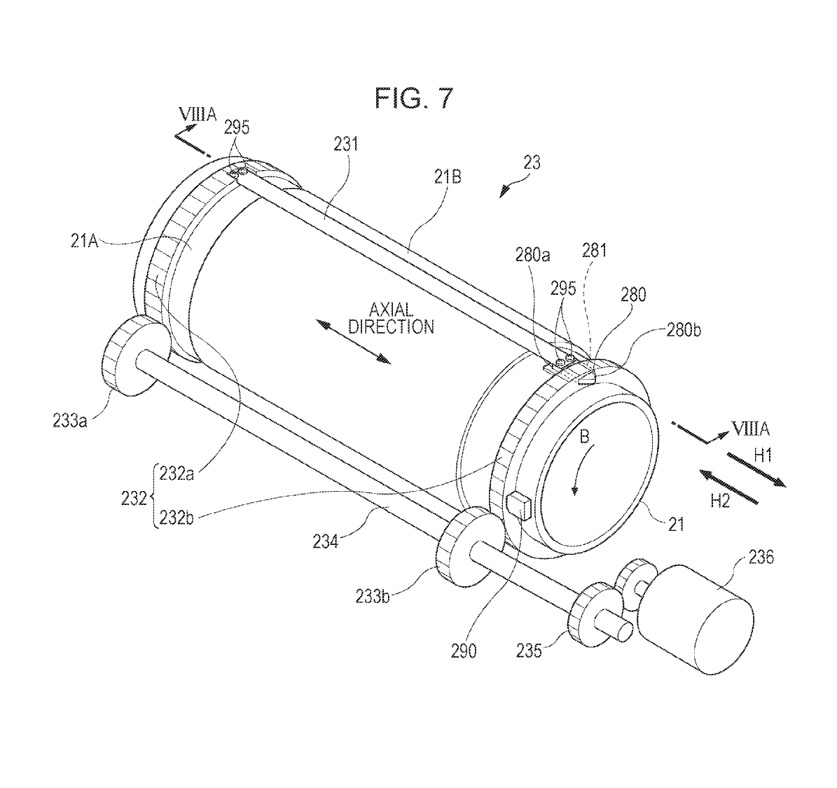

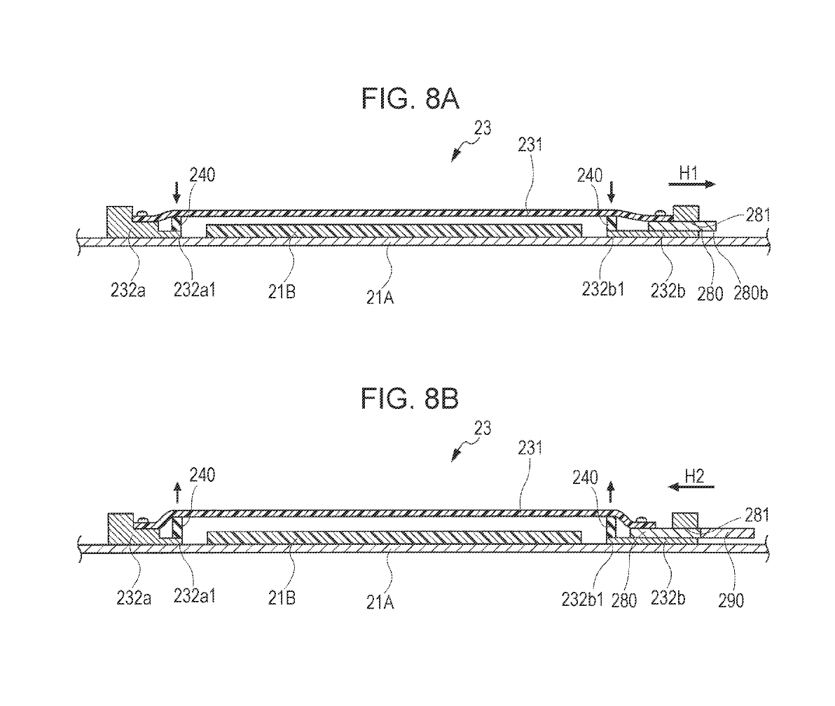

FIG. 7 is a schematic view of the trailing end gripper 23. FIG. 8A is a sectional view taken along line VIIIA-VIIIA of FIG. 7, and FIG. 8B is a sectional view illustrating another state.

The trailing end gripper 23 includes a sheet restraining portion 231, a rotary member 232, and an actuation tab 280. The sheet restraining portion 231 is disposed so as to face the outer peripheral surface of the transfer drum 21 and restrains the sheet S from rising from the outer peripheral surface of the transfer drum 21. The rotary member 232 holds both ends of the sheet restraining portion 231 in the longitudinal direction and rotates around the axis of the transfer drum 21. The actuation tab 280 changes the shape of the sheet restraining portion 231. A lug portion 290, which comes into contact with the actuation tab 280 of the trailing end gripper 23, is directly or indirectly fixed to the housing 2.

The sheet restraining portion 231 is a rectangular-parallelepiped-shaped (plate-shaped) member having a width in the tangential direction of the outer peripheral surface of the transfer drum 21, a width in the rotational axis direction of the transfer drum 21, and a thickness in the radial direction of the transfer drum 21. The sheet restraining portion 231 is disposed so as to extend in the rotational axis direction so that the width in the rotational axis direction is larger than the width in the tangential direction. As illustrated in FIG. 7, the width of the sheet restraining portion 231 in the rotational axis direction is larger than the width of the elastic layer 21B of the transfer drum 21 (the length of the transfer drum 21 in the rotational axis direction). The sheet restraining portion 231 need not be rectangular-parallelepiped-shaped and may have a width along the circumference of the transfer drum 21 instead of in the tangential direction of the outer periphery of the transfer drum 21. Hereinafter, the meaning of the term “transport direction of the sheet S”, when the term is used in relation to the sheet restraining portion 231, includes both the circumferential direction of the transfer drum 21 and the tangential direction of the transfer drum 21.

The sheet restraining portion 231 is made of, for example, a resin such as PET (Polyethylene terephthalate), a polyimide resin, or a fluorocarbon resin and is elastically deformable. The sheet restraining portion 231 has a rigidity that allows the sheet restraining portion 231 to be warped in the longitudinal direction (rotational axis direction). The sheet restraining portion 231 has a small thickness and does not have edges so that the photoconductor drum 11 may not be damaged even if the sheet restraining portion 231 comes into contact with the photoconductor drum 11 in the transfer region Tr.

The material of the sheet restraining portion 231 is not limited to a resin and may be a metal. That is, the sheet restraining portion 231 may be a thin metal plate.

The rotary member 232 includes a first rotary member 232a and a second rotary member 232b, which are cylindrical members with gears formed on the outer peripheral surfaces thereof. The first rotary member 232a and the second rotary member 232b are disposed at ends of the transfer drum 21 in the rotational axis direction so as to be coaxial with the transfer drum 21. The rotary member 232 includes a first transmission gear 233a and a second transmission gear 233b, which respectively mesh with the gears formed on the outer peripheral surfaces of the first rotary member 232a and the second rotary member 232b. The rotary member 232 includes a rotary shaft 234, a gear 235, and a rotary member motor 236. The rotary shaft 234 is disposed along the axis of the first transmission gear 233a and the second transmission gear 233b. The gear 235 is disposed at an end of the rotary shaft 234 in the axial direction. The rotary member motor 236 supplies rotational driving force to the first rotary member 232a and the second rotary member 232b through the gear 235 and the two transmission gears 233a and 233b.

With this structure, the first rotary member 232a and the second rotary member 232b are rotatable around the transfer drum 21 at a uniform speed and independently of the transfer drum 21. Thus, the position of the sheet restraining portion 231 relative to the position of the transfer drum 21 in the rotation direction is changeable.

A first end of the sheet restraining portion 231 in the rotational axis direction is screwed to the first rotary member 232a with a pair of screws 295 that are arranged in a direction perpendicular to the rotational axis direction. A second end of the sheet restraining portion 231 is connected to the second rotary member 232b through the actuation tab 280. The second end of the sheet restraining portion 231 in the rotational axis direction is screwed to the actuation tab 280 with a pair of screws 295 that are arranged in a direction perpendicular to the rotational axis direction. A through-hole 281 extending in the rotational axis direction is formed in the second rotary member 232b.

As illustrated in FIGS. 8A and 8B, a first elastic member holding portion 232a1 is disposed on the first rotary member 232a at a position that is the same, in the circumferential direction, as the positions at which screw holes for screwing the sheet restraining portion 231 are formed and that is inside the positions of the screw holes in the rotational axis direction. The first elastic member holding portion 232a1 supports an elastic member 240 so that the elastic member 240 protrudes away from the outer peripheral surface of the transfer drum 21 in the radial direction. Likewise, as illustrated in FIGS. 8A and 8B, a second elastic member holding portion 232b1 is disposed on the second rotary member 232b at a position that is the same, in the circumferential direction, as the position of the through-hole 281 and that is inside the position of the through-hole 281 in the rotational axis direction. The second elastic member holding portion 232b1 supports an elastic member 240 so that the elastic member 240 protrudes away from the outer peripheral surface of the transfer drum 21 in the radial direction. Each of the elastic members 240 is, for example, a rubber member or a spring member that elastically extends and contracts in the radial direction of the transfer drum 21.

The actuation tab 280 is a plate-shaped member that is inserted into the through-hole 281 formed in the second rotary member 232b. The actuation tab 280 is movable along the rotational axis direction (indicated by arrows H1 and H2). The actuation tab 280 is urged by a spring member (not shown) in the rotational axis direction from a middle portion toward an end portion of the transfer drum 21 (direction of arrow H1). The second end of the sheet restraining portion 231 in the rotational axis direction is screwed to an inner end portion 280a of the actuation tab 280 in the rotational axis direction. An outer end portion 280b of the actuation tab 280 in the rotational axis direction has a tapered shape having a tip at the middle thereof in the circumferential direction. When the actuation tab 280 is not in contact with the lug portion 290 described below, the actuation tab 280 protrudes to a position outside an outer end of the second rotary member 232b in the rotational axis direction (as illustrated in FIG. 8A). When the actuation tab 280 comes into contact with the lug portion 290 and is pressed by the lug portion 290, the actuation tab 280 moves in the rotational axis direction from the end portion toward the middle portion (in the direction of arrow H2) (as illustrated in FIG. 8B).

The lug portion 290 is a plate-shaped member that is directly or indirectly fixed to the housing 2 at a position that is outside an outer end of the second rotary member 232b and that is in a rotation path of the outer end portion 280b of the actuation tab 280. The lug portion 290 comes into contact with the outer end portion 280b of the actuation tab 280, which rotates together with the second rotary member 232b, and thereby moves the actuation tab 280 in the rotational axis direction from the end portion toward the middle portion (the direction of arrow H2). On the other hand, the lug portion 290 does not come into contact with members other than the actuation tab 280.

In the trailing end gripper 23 having the structure described above, when the rotary member 232 rotates and the outer end portion 280b of the actuation tab 280 comes into contact with the lug portion 290, the actuation tab 280 moves in the rotational axis direction from the end portion toward the middle portion as illustrated in FIG. 8B (direction of arrow H2). As a result, the sheet restraining portion 231, which is connected to the inner end portion 280a of the actuation tab 280, which has moved in the direction of arrow H2, receives a compressive force in the rotational axis direction. As illustrated in FIG. 8B, when the sheet restraining portion 231 receives the compressive force in the rotational axis direction, a force with which the sheet restraining portion 231 presses the elastic member 240 in the radial direction of the transfer drum 21 becomes smaller and relaxes the elastic deformation of the elastic member 240. That is, the elastic member 240 extends. Thus, the sheet restraining portion 231 moves to a position that is farther from the elastic layer 21B of the transfer drum 21.

When the rotary member 232 rotates from a state in which the outer end portion 280b of the actuation tab 280 and the lug portion 290 are in contact with each other and the outer end portion 280b of the actuation tab 280 becomes separated from the lug portion 290, the actuation tab 280 moves in the rotational axis direction from the middle portion toward the end portion (direction of arrow H1) as illustrated in FIG. 8A. As compared with the state illustrated in FIG. 8B, the outer end portion 280b of the actuation tab 280 protrudes from the outer end portion of the second rotary member 232b in the rotational axis direction. As a result, the sheet restraining portion 231, which is connected to the inner end portion 280a of the actuation tab 280, which has moved in the direction of arrow H1, is pulled by the actuation tab 280. As illustrated in FIG. 8A, when the sheet restraining portion 231 is pulled, a force with which the sheet restraining portion 231 presses the elastic member 240 in the radial direction of the transfer drum 21 becomes larger and contracts the elastic member 240. Thus, the gap between the sheet restraining portion 231 and the elastic layer 21B decreases as compared with the state illustrated in FIG. 8B.

Hereinafter, a stretched state of the trailing end gripper 23 refers to a state, as illustrated in FIG. 8A, in which the outer end portion 280b of the actuation tab 280 is not in contact with the lug portion 290 and the actuation tab 280 does not receive a force from the lug portion 290 and in which the sheet restraining portion 231 compresses the elastic member 240 and the sheet restraining portion 231 is located nearer the outer peripheral surface of the transfer drum 21. A relaxed state of the trailing end gripper 23 refers to a state, as illustrated in FIG. 8B, in which the outer end portion 280b of the actuation tab 280 is in contact with the lug portion 290 and thereby the actuation tab 280 is moved in the rotational axis direction from the end portion toward the middle portion (direction of arrow H2) and the sheet restraining portion 231 is farther from the outer peripheral surface of the transfer drum 21 than in the state illustrated in FIG. 8A.

In the relaxed state, in which the outer end portion 280b of the actuation tab 280 of the second rotary member 232b is in contact with the lug portion 290, the trailing end gripper 23 waits while the leading end of the sheet S in the transport direction, which has been fed from the sheet feeding section 50, passes thereunder until the tailing end of the sheet S in the transport direction arrives. A standby position of the trailing end gripper 23 refers to a position thereof at which the outer end portion 280b of the actuation tab 280 of the second rotary member 232b is in contact with the lug portion 290 and the trailing end gripper 23 is in the relaxed state. The standby position of the trailing end gripper 23 according to the present exemplary embodiment is located between the sheet feeding position Pa and the transfer region Tr, where the sheet feeding position Pa is a position at which the sheet S, which has been transported through a sheet feeding path 62, reaches the outer peripheral surface of the transfer drum 21 (see FIG. 2). In other words, the standby position is determined such that a position Pc (see FIG. 2) is located between the sheet feeding position Pa and the transfer region Tr, where Pc is the position at which an upstream end portion in the rotation direction of the sheet restraining portion 231, which is a plate-shaped member having a width in the circumferential direction of the transfer drum 21, faces the transfer drum 21 (see FIG. 2). When the trailing end gripper 23 is in a relaxed state at the standby position, the leading end gripper 22, which is gripping the sheet S, is allowed to pass through the gap between the sheet restraining portion 231 and the axis of the transfer drum 21.

Next, the fixing section 40 will be described.

The fixing section 40 includes a heating roller 41 and a pressing roller 42. The heating roller 41 is a rotatable member including a heater (not shown). The pressing roller 42 is disposed so as to be in contact with the heating roller 41 and thereby forms a fixing nip with the heating roller 41.

Next, the sheet feeding section 50 will be described.

The sheet feeding section 50 includes a sheet container 51, a pick-up roller 52, and a pair of supply rollers 53. The sheet container 51 is disposed below the transfer drum 21 and contains sheets S. The pick-up roller 52 picks up one of the sheets S from the sheet container 51. The pair of supply rollers 53 supply the sheet S, which has been picked up by the pick-up roller 52, to the transfer drum 21 with an appropriate timing. The sheet feeding section 50 includes a guide member 54, a first sheet detection sensor 55, and a second sheet detection sensor 56. The guide member 54 guides the sheet S, which has been picked up by the pick-up roller 52, to the supply rollers 53. The first sheet detection sensor 55 is disposed in a transport path between the pick-up roller 52 and the supply rollers 53 and detects the sheet S that is guided by the guide member 54. The second sheet detection sensor 56 detects the sheet S at a position that is downstream of the supply rollers 53 and upstream of the standby position of the trailing end gripper 23.

The first sheet detection sensor 55 is, for example, an existing transmissive photo-interrupter sensor. The first sheet detection sensor 55 includes two protruding portions, a light-emitting element (not shown) disposed on one of the protruding portions, and a light-receiving element (not shown) disposed on the other protruding portion. The protruding portions are formed on a sensor body and directly or indirectly attached to the housing 2. The first sheet detection sensor 55 detects whether the sheet S is passing through a space between the light-emitting element and the light-receiving element or the sheet S is present in the space on the basis of whether the light-receiving element receives light emitted from the light-emitting element. When the light-receiving element does not receive light emitted from the light-emitting element, the first sheet detection sensor 55 detects the presence of the sheet S in the space between the light-emitting element and the light-receiving element, and outputs a signal indicating the presence (ON signal) to a controller 100. On the other hand, when the light-receiving element does not receive light emitted from the light-emitting element, the first sheet detection sensor 55 detects the absence of the sheet S in the space between the light-emitting element and the light-receiving element, and outputs a signal indicating the absence (OFF signal) to the controller 100. If the controller 100 receives a detection signal indicating the presence of the sheet S (ON signal) after receiving a detection signal indicating the absence of the sheet S (OFF signal), the controller 100 determines that the leading end of the sheet S has passed. If the controller 100 receives a detection signal indicating the absence of the sheet S (OFF signal) after receiving a detection signal indicating the presence of the sheet S (ON signal), the controller 100 determines that the trailing end of the sheet S has passed.

The second sheet detection sensor 56, which is a reflective photo-interrupter sensor, emits near-infrared light toward the sheet S that is being transported along the transport path between the supply rollers 53 and the transfer drum 21 and detects the presence or the absence of the sheet S on the basis of whether or not reflected light (near-infrared light) from the sheet S is received. When the second sheet detection sensor 56 receives the reflected light, the second sheet detection sensor 56 detects the presence of the sheet S, and outputs a signal indicating the presence of the sheet S (ON signal) to the controller 100. On the other hand, when the second sheet detection sensor 56 does not receive the reflected light, the second sheet detection sensor 56 detects the absence of the sheet S, and outputs a signal indicating the absence of the sheet S (OFF signal) to the controller 100. If the controller 100 receives a detection signal indicating the presence of the sheet S (ON signal) after receiving a detection signal indicating the absence of the sheet S (OFF signal), the controller 100 determines that the leading end of the sheet S has passed. If the controller 100 receives a detection signal indicating the absence of the sheet S (OFF signal) after receiving a detection signal indicating the presence of the sheet S (ON signal), the controller 100 determines that the trailing end of the sheet S has passed.

Instead of the transmissive photo-interrupter sensor, which is described above as an example, the first sheet detection sensor 55 according to the present exemplary embodiment may be a reflective photo-interrupter sensor or a photo-sensor with an actuator. Instead of the reflective photo-interrupter sensor, which is described above as an example, the second sheet detection sensor 56 according to the present exemplary embodiment may be a transmissive photo-interrupter sensor or a photo-sensor with an actuator.

In the following description, a transport path of the sheet S extending from the sheet container 51 to the supply rollers 53 will be referred to as a sheet feeding path 61 (see FIG. 1), and a transport path of the sheet S extending from the supply rollers 53 toward the transfer drum 21 will be referred to as the sheet feeding path 62 (see FIG. 1). A transport path of the sheet S along the outer peripheral surface of the transfer drum 21 will be referred to as a rotation path 63 (see FIG. 1), and a transport path of the sheet S extending from the transfer region Tr toward the fixing section 40 will be referred to as the sheet output path 64 (see FIG. 1).

Next, the controller 100 will be described.

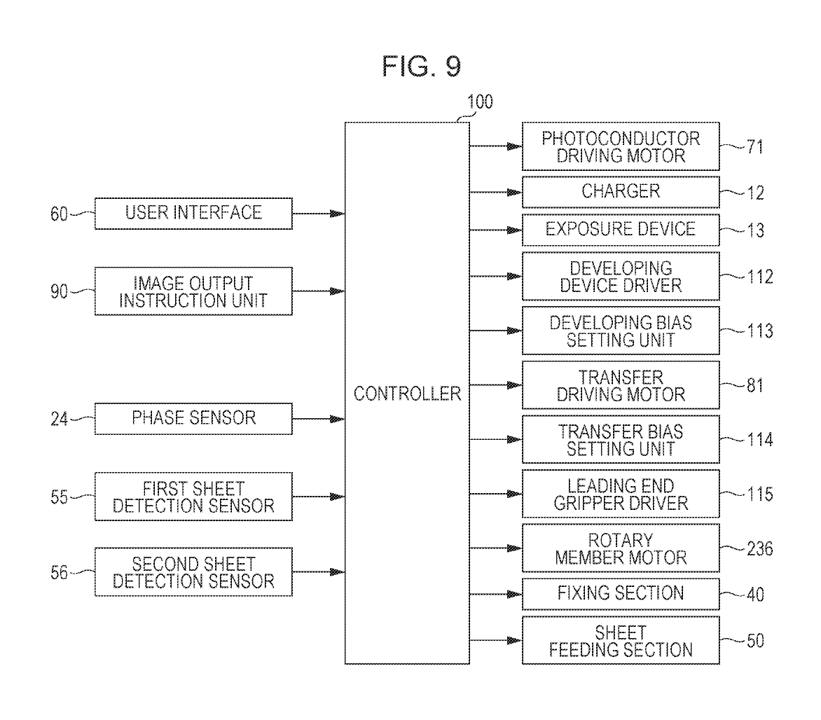

FIG. 9 is a functional block diagram of the controller 100.

The controller 100 receives a signal from a user interface 60 that has received an instruction from a user. The controller 100 receives an image signal from an image output instruction unit 90, which is disposed inside or outside the image forming apparatus 1. The controller 100 receives a phase signal of the transfer drum 21 sent from the phase sensor 24 and detection signals sent from the first sheet detection sensor 55 and the second sheet detection sensor 56.

The controller 100 outputs control signals to the photoconductor driving motor 71, the charger 12, the exposure device 13, a developing device driver 112, and a developing bias setting unit 113. The photoconductor driving motor 71 rotates the photoconductor drum 11. The developing device driver 112 rotates/stops the rotary developing device 14 so that a desired developing unit is positioned at the development position at which the developing unit faces the photoconductor drum 11. The developing bias setting unit 113 sets a developing bias that is supplied to the developing unit located at the development position. The controller 100 outputs control signals to the transfer driving motor 81, a transfer bias setting unit 114, a leading end gripper driver 115, the rotary member motor 236, the sheet feeding section 50, and the fixing section 40. The transfer driving motor 81 rotates the transfer drum 21. The transfer bias setting unit 114 sets a transfer bias that is supplied to the transfer drum 21. The leading end gripper driver 115 rotates the rotary shaft 223 of the leading end gripper 22. The rotary member motor 236 rotates the rotary member 232 of the trailing end gripper 23.

The controller 100 performs control such that a condition Vt<Vp<Vs is satisfied, where Vp is the peripheral velocity of the photoconductor drum 11 that rotates in the direction of arrow A, Vt is the peripheral velocity of the transfer drum 21 that rotates in the direction of arrow B, and Vs is the peripheral velocity of the pair of supply rollers 53.

Next, a transfer process performed by the controller 100 will be described by using a flowchart.

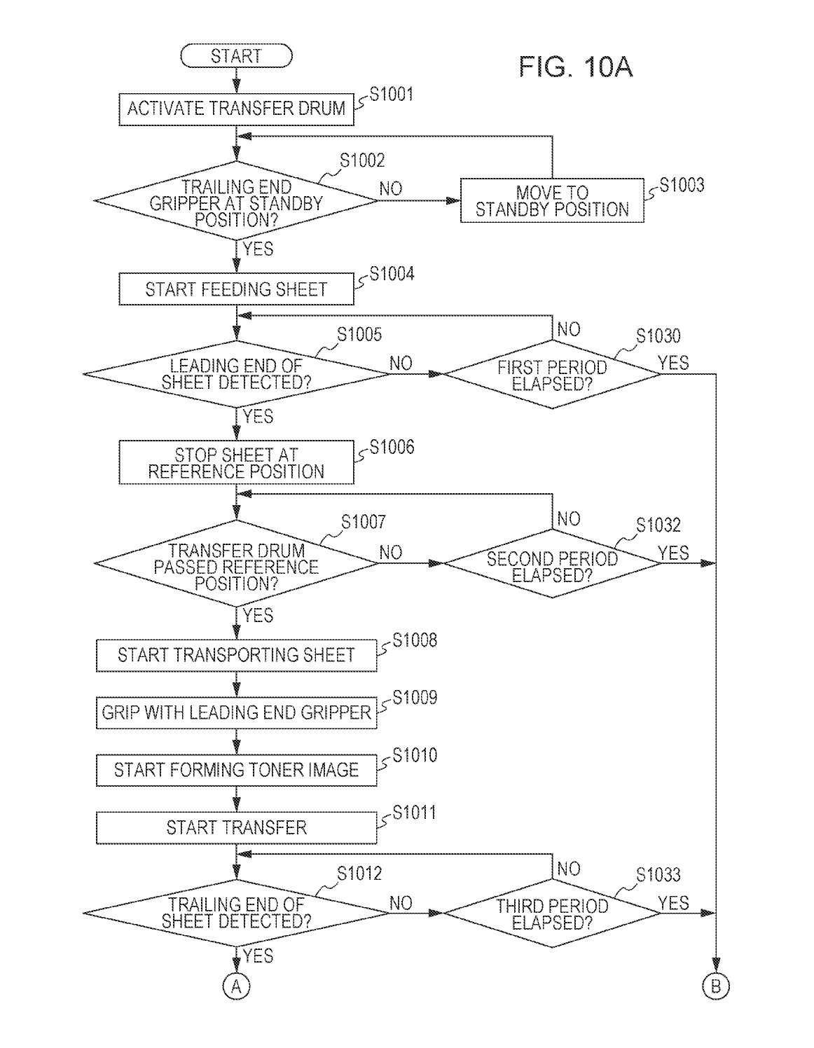

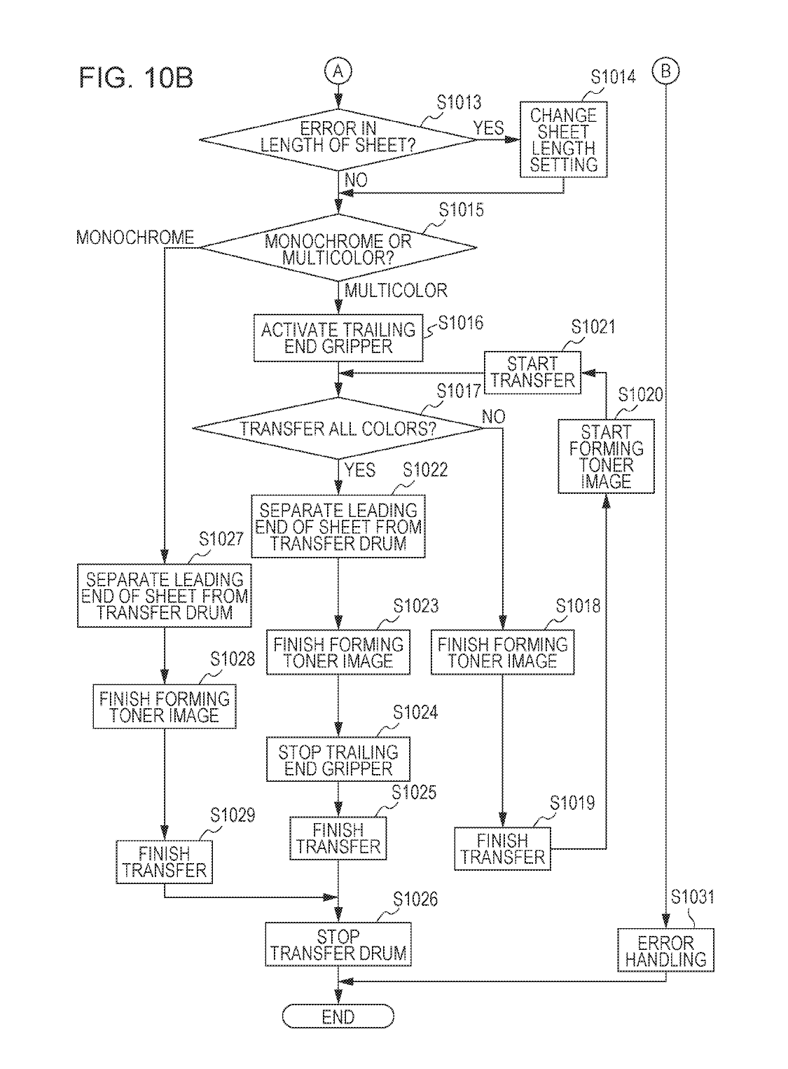

FIGS. 10A and 10B illustrate a flowchart of the transfer process performed by the controller 100. The controller 100 performs this transfer process when the controller 100 receives an instruction to form an image on the sheet S.

First, the controller 100 activates the transfer drum (step 1001 (hereinafter, “step” will be abbreviated to “S”)). In this step, the controller 100 drives the transfer driving device 80 to rotate the transfer drum 21.

Subsequently, the controller 100 determines whether or not the trailing end gripper 23 is present at the standby position (S1002). In this step, the controller 100 determines whether or not the trailing end gripper 23 is present at the standby position on the basis of a detection signal of a standby position sensor (not shown) for detecting the position of the trailing end gripper 23. If the trailing end gripper 23 is absent at the standby position (“NO” in S1002), the controller 100 rotates the rotary member motor 236, moves the trailing end gripper 23 to the standby position on the basis of the detection signal of the standby position sensor (S1003), and performs steps after S1002.

On the other hand, if the trailing end gripper 23 is present at the standby position (“YES” in S1002), the controller 100 starts feeding the sheet S from the sheet feeding section 50 to the transfer drum 21 (S1004). In this step, the controller 100 feeds the sheet S to the sheet feeding path 61 and the sheet feeding path 62 by using the pick-up roller 52 and the supply rollers 53.

Subsequently, the controller 100 determines whether or not the second sheet detection sensor 56 has detected the leading end of the sheet S (S1005). This determination is made on the basis of whether the controller 100 has received a detection signal indicating that the sheet S is present (ON signal) after receiving a detection signal indicating that the sheet S is absent (OFF signal) from the second sheet detection sensor 56. If the second sheet detection sensor 56 has detected the leading end of the sheet S (“YES” in S1005), the controller 100 stops the sheet S at a predetermined reference position on the sheet feeding path (S1006).

Subsequently, the controller 100 determines whether or not a position on the transfer drum 21 in the circumferential direction passes the predetermined reference position (S1007). In this step, the controller 100 determines whether or not the transfer drum 21 rotates normally on the basis of a detection signal of a reference position sensor (not shown) for detecting the position of the transfer drum 21. If the transfer drum 21 has passed the reference position (“YES” in S1007), with reference to the timing with which the transfer drum 21 passed the reference position, the controller 100 causes the supply rollers 53 to start transporting the sheet S with a timing (a calculated phase of the transfer drum 21) such that the sheet S reaches the sheet feeding position Pa when the leading end gripper 22 reaches the sheet feeding position Pa (S1008).

Subsequently, when the leading end of the sheet S in the transport direction reaches the sheet feeding position Pa, the controller 100 changes the state of the leading end gripper 22 from the open state to the closed state and causes the leading end gripper 22 to grip the leading end of the sheet S in the transport direction (S1009).

Subsequently, the controller 100 starts forming a toner image on the photoconductor drum 11 in accordance with the calculated phase of the transfer drum 21 or the reference position of the transfer drum 21 (S1010). First, the controller 100 starts charging the photoconductor drum 11 with the charger 12. Then, the controller 100 starts transferring the toner image, which has been formed on the photoconductor drum 11, to the sheet S (S1011).

Subsequently, the controller 100 determines whether or not the first sheet detection sensor 55 has detected the trailing end of the sheet S in the transport direction (S1012). This determination is made on the basis of whether the controller 100 has received a detection signal indicating that the sheet S it absent (OFF signal) after receiving a detection signal indicating that the sheet S is present (ON signal) from the first sheet detection sensor 55.

If the first sheet detection sensor 55 has detected the trailing end of the sheet S (“YES” in S1012), the controller 100 determines whether or not there is an error between the length of the sheet S that has been transported along the sheet feeding path 61 and the length of a sheet on which an image to be formed, which has been calculated on the basis of a signal sent from the user interface 60 or the image output instruction unit 90 (S1013). The length of the sheet S that has been transported along the sheet feeding path 61 is calculated by measuring a period between the time at which the sheet S was started to be transported by the supply rollers 53 in step S1008 and the time at which the first sheet detection sensor 55 detected the trailing end of the sheet S. The controller 100 determines whether or not there is an error by comparing the length of the sheet S calculated on the basis of the detection result of the first sheet detection sensor 55 with the length of the sheet S on which an image is to be formed.

If there is an error in the length of the sheet (“YES” in S1013), the controller 100 changes the length of the sheet S on which an image is to be formed to the length of the actually transported sheet S (S1014). On the basis of this change in the setting, the controller 100 changes the position of the trailing end gripper 23 relative to the transfer drum 21 and the position at which forming of a toner image is to be finished. Thus, a toner image corresponding to the length of the actually transported sheet S is formed on the photoconductor drum 11.

If there is not an error in the length of the sheet (“NO” in S1013) or the length of the sheet S is changed in S1014, the controller 100 determines whether or not the instructed transfer mode is a multicolor mode in which a multicolor image is formed on a single sheet S by using two to four of yellow, magenta, cyan, and black toners or the instructed transfer mode is a monochrome mode in which a monochrome image is formed on a single sheet S by using one of yellow, magenta, cyan, and black toners (S1015). This determination is made on the basis of a signal sent from the user interface 60 or a signal sent from the image output instruction unit 90.

If the instructed transfer mode is a multicolor mode (determination result in S1015 is a multicolor mode), the controller 100 controls driving of the rotary member motor 236 so that the sheet restraining portion 231 of the trailing end gripper 23 faces a trailing end portion of the sheet S that is being transported along the rotation path 63 (S1016). For example, after the controller 100 has received a signal indicating detection of the tailing end of the sheet from the first sheet detection sensor 55, the controller 100 waits for a predetermined time and then drives the rotary member motor 236. The predetermined time is determined on the basis of the position at which the first sheet detection sensor 55 is disposed, the velocity with which the supply rollers 53 supplies the sheet S (supply peripheral velocity Vs), the rotation speed of the transfer drum 21 (transfer peripheral velocity Vt), and the standby position of the trailing end gripper 23. After the controller 100 has started transporting the sheet in S1008, the controller 100 waits for a predetermined time and then starts driving the rotary member motor 236. The predetermined time is determined on the basis of the length of the sheet S that has been set on the basis of a signal sent from the user interface 60 or a signal sent from the image output instruction unit 90, the length of the sheet S changed in step S1014, the rotation speed of the transfer drum 21 (transfer peripheral velocity Vt), and the standby position of the trailing end gripper 23. As the rotary member motor 236 rotates, the sheet restraining portion 231 of the trailing end gripper 23 rotates in synchronism with the transfer drum 21 and the state of the trailing end gripper 23 changes from the relaxed state to the stretched state.

Subsequently, the controller determines whether or not transfer of all colors will be finished when transfer of a color that is currently being transferred will be finished (S1017). If transfer of all colors will not be finished (“NO” in S1017), the controller 100 finishes forming a toner image on the photoconductor drum 11 (S1018) and finishes transferring the toner image to the sheet S (S1019). Then, the controller 100 starts forming a toner image of the next color on the photoconductor drum 11 (S1020), and starts transferring the toner image formed on the photoconductor drum 11 to the sheet S (S1021). In step S1021, the controller 100 causes the sheet S to rotate together with the transfer drum 21 while the leading end gripper 22 grips the leading end portion of the sheet S and the trailing end gripper 23 restrains the tailing end of the sheet S from rising.

If transfer of all colors will be finished (“YES” in S1017), the controller 100 performs a step of separating the leading end of the sheet S from the transfer drum 21 (S1022). For example, the state of the leading end gripper 22 is changed from the closed state to the open state. Then, forming of a toner image on the photoconductor drum 11 is finished (S1023), and rotation of the trailing end gripper 23 is stopped (S1024). Subsequently, transfer of the toner image to the sheet S is finished (S1025), and the transfer drum 21 is stopped (S1026).

On the other hand, if the instructed transfer mode is a monochrome mode (determination result in S1015 is a monochrome mode), a step of separating the leading end of the sheet S from the transfer drum 21 is performed (S1027), forming of a toner image on the photoconductor drum 11 is finished (S1028), transfer of the toner image to the sheet S is finished (S1029), and the transfer drum 21 is stopped (S1026).

If the second sheet detection sensor 56 has not detected the leading end of the sheet S (“NO” in S1005), the controller 100 determines whether or not a predetermined first period has elapsed (S1030). The first period is set to be a period that is sufficient for the sheet S, which has been started to be supplied in step S1004, to be picked up by the pick-up roller 52 and transported by the supply rollers 53, and to reach a detection position of the second sheet detection sensor 56.

If the first period has not elapsed (“NO” in S1030), the controller 100 performs steps after step S1005. If the first period has elapsed (“YES” in S1030), the controller 100 performs an error handling step (S1031). In the error handling step, the controller 100 notifies a user of an error by using light or a sound. If the leading end portion of the sheet S is gripped by the leading end gripper 22, the leading end gripper 22 is made to release the leading end portion of the sheet S.

If the transfer drum 21 has not passed the reference position (“NO” in S1007), the controller 100 determines whether or not a predetermined second period has elapsed (S1032). The second period is set to be a period that is sufficient for the transfer drum 21, which has been activated in step S1001, to reach the detection position of the reference position sensor. If the second period has not elapsed (“NO” in S1032), the controller 100 performs steps after step S1007. If the second period has elapsed (“YES” in S1032), the controller performs an error handling step (S1031).

If the first sheet detection sensor 55 has not detected the trailing end of the sheet S (“NO” in S1012), the controller 100 determines whether or not a predetermined third period has elapsed (S1033). The third period is set to be a period that is sufficient for the trailing end of the sheet S (the trailing end with consideration of the length of any sheet on which the image forming apparatus 1 is capable of forming an image), which has been started to be transported in step S1008 and transported by the supply rollers 53, to reach the detection position of the first sheet detection sensor 55.

If the third period has not elapsed (“NO” in S1033), steps after step S1012 are performed. If the third period has elapsed (“YES” in S1033), an error handling step is performed (S1031).

Next, an image forming operation with which the image forming apparatus 1, which is configured and controlled by the controller 100 as described above, forms a multicolor color image on a single sheet S will be described.

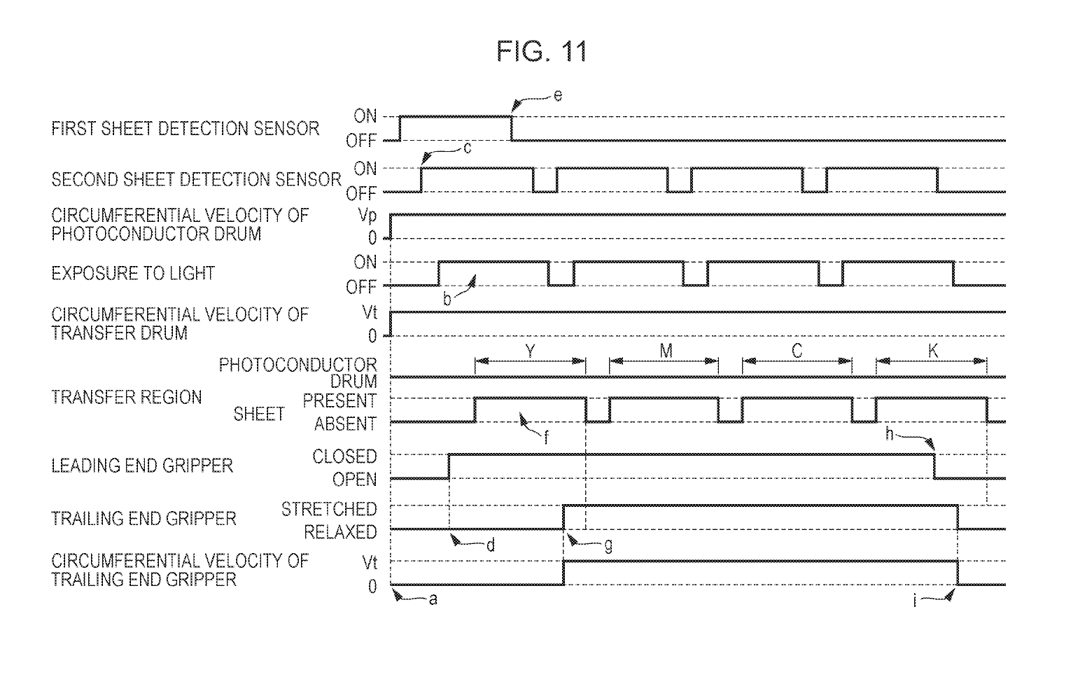

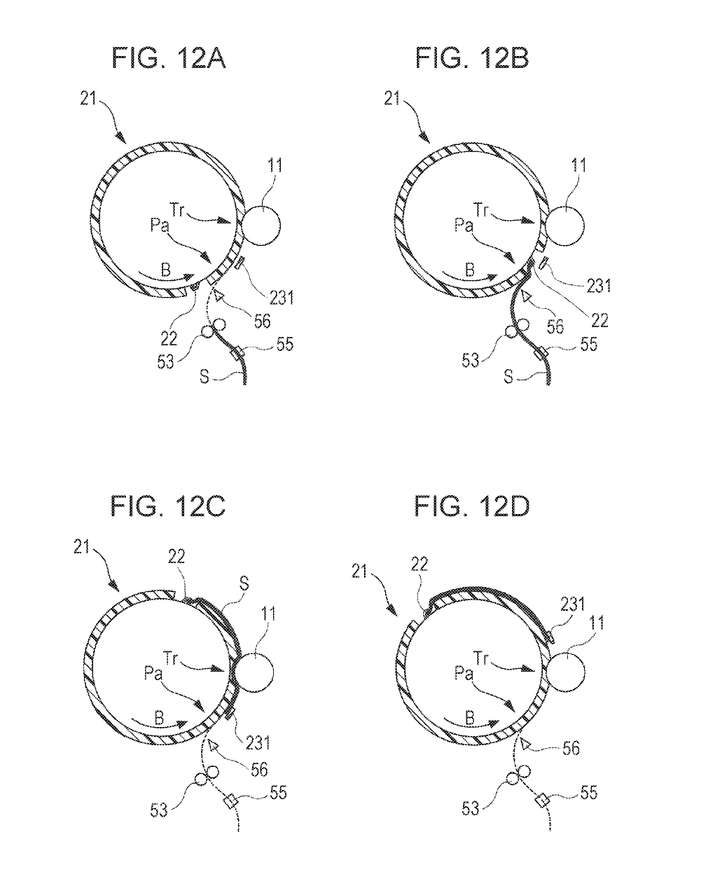

FIG. 11 is a timing chart of the image forming operation. FIGS. 12A to 12D illustrate an operation with which the sheet S is wound around the transfer drum 21.

Image data of a reflected color image of a document read by a document reader (not shown) or image data generated by a personal computer (not shown) is input to an image signal processor (not shown) as data items for, for example, red (R), green (G), and blue (B), and subjected to predetermined image processing. The image data that has been processed is converted to color gradation data for yellow (Y), magenta (M), cyan (C), and black (K), and output to the exposure device 13 (see FIG. 1).

As the image forming operation starts, the photoconductor drum 11 and the transfer drum 21 start rotating in synchronism with each other (see FIG. 12A). At this time, the leading end gripper 22 is open, and the trailing end gripper 23 is relaxed (see arrow a in FIG. 11).

Moreover, at this time, the leading end gripper 22 is rotating together with the transfer drum 21, and the trailing end gripper 23 is at rest at the standby position (the peripheral velocity is zero). The actuation tab 280 of the trailing end gripper 23 is in contact with the lug portion 290 (see FIG. 7) and thereby is pushed toward the middle portion of the transfer drum 21, and the sheet restraining portion 231 is warped in a direction away from the elastic layer 21B.

After the photoconductor drum 11, which is rotating, has been charged by the charger 12, the exposure device 13 forms an electrostatic latent image of a first color (for example, yellow) in accordance with image information (see arrow b in FIG. 11). As the transfer drum 21 starts rotating, the phase sensor 24 measures the phase of the transfer drum 21. The measured phase is sent to the controller 100.

In the rotary developing device 14, a developing unit that contains a color toner corresponding to the electrostatic latent image to be formed on the photoconductor drum 11 has been rotated and stopped at a position at which the developing unit faces the photoconductor drum 11.

The developing unit 14Y, for example, develops the electrostatic latent image on the photoconductor drum 11, and thereby a toner image is formed on the photoconductor drum 11. As the photoconductor drum 11 rotates, the toner image (here, a yellow toner image) is transported to the transfer region Tr at which the photoconductor drum 11 faces the transfer section 20.

The sheet S is supplied in correspondence with the start of the image forming operation. To be specific, the sheet S is fed along the sheet feeding path 61 by using the pick-up roller 52 and the supply rollers 53. The first sheet detection sensor 55 detects passing of the leading end of the sheet S in the transport direction, the second sheet detection sensor 56 detects passing of the leading end of the sheet S in the transport direction (see arrow C in FIG. 11), and a detection signal is sent to the controller 100. When receiving the detection signal, the controller 100 controls transporting of the sheet S so that the sheet S reaches the sheet feeding position Pa when the leading end gripper 22 reaches the outer peripheral surface (sheet feeding position Pa) of the transfer drum 21. The state of the leading end gripper 22 changes from the open state to the closed state (see arrow d in FIG. 11) when the leading end of the sheet S in the transport direction reaches the sheet feeding position Pa. As a result, the leading end gripper 22 grips the leading end of the sheet S in the transport direction (see FIG. 12B). At this time, the trailing end gripper 23 is at rest at the standby position in a relaxed state (see arrow d in FIG. 11).

The leading end gripper 22, which is gripping the sheet S, passes through a space between the sheet restraining portion 231 of the trailing end gripper 23, which is at rest, and the axis of the transfer drum 21 (moves past the trailing end gripper 23, which is at rest). The leading end gripper 22, which has passed through the space between the sheet restraining portion 231 of the trailing end gripper 23 and the rotation axis of the transfer drum 21, passes the transfer region Tr while gripping the sheet S.

The sheet S, which has passed the transfer region Tr while being gripped by the leading end gripper 22 (see arrow f in FIG. 11), is transported along the rotation path 63 while being gripped by the leading end gripper 22 and wound around the transfer drum 21.

The exposure device 13 forms an electrostatic latent image of the first color (for example, yellow) in accordance with the image information, and then the first sheet detection sensor 55 detects passing of the tailing end of the sheet S in the transport direction (see arrow e in FIG. 11). The controller 100 receives a detection signal from the first sheet detection sensor 55 and issues an instruction to the rotary member motor 236, which rotates the rotary member 232 of the trailing end gripper 23. At this time, the controller 100 controls driving of the rotary member motor 236 so that the sheet restraining portion 231 of the trailing end gripper 23 faces the trailing end portion of the sheet S that is transported along the rotation path 63. For example, after the controller 100 has received a signal indicating detection of the trailing end of the sheet from the first sheet detection sensor 55, the controller 100 waits for a predetermined time and then drives the rotary member motor 236. The predetermined time is determined on the basis of the position at which the first sheet detection sensor 55 is disposed, the velocity with which the supply rollers 53 supply the sheet S (supply peripheral velocity Vs), the rotation speed of the transfer drum 21 (transfer peripheral velocity Vt), and the standby position of the trailing end gripper 23. As the rotary member motor 236 rotates, the sheet restraining portion 231 of the trailing end gripper 23 rotates in synchronism with the transfer drum 21 and the state of the trailing end gripper 23 changes from the relaxed state to the stretched state (see arrow g in FIG. 11).

When the trailing end gripper 23 is in the stretched state, the exposure device 13 has finished forming the electrostatic latent image of the first color (for example, yellow), and the exposure device 13 has not yet started forming an electrostatic latent image of a second color (magenta). That is, while an electrostatic latent image is being formed (during exposure to light), the state of the trailing end gripper 23 is not changed. Therefore, the electrostatic latent image is not blurred due to a change in the state the trailing end gripper 23.

After starting rotation, the trailing end gripper 23 rotates together with the transfer drum 21 while restraining the trailing end of the sheet S, which is wrapped around the transfer drum 21, in the transport direction from rising. In other words, the sheet S rotates together with the transfer drum 21 while the leading end of the sheet S is gripped by the leading end gripper 22 and the trailing end of the sheet S is held by the trailing end gripper 23 (see FIG. 12D).

When the sheet S passes the transfer region Tr, the leading end gripper 22, which is gripping the sheet S, does not come into contact with the photoconductor drum 11. In contrast, the sheet restraining portion 231 of the trailing end gripper 23, which is holding the sheet S, comes into contact with the photoconductor drum 11.

The first toner image (for example, a yellow toner image) formed on the photoconductor drum 11 is transferred to the sheet S on the transfer drum 21 in the transfer region Tr, at which the photoconductor drum 11 and the transfer drum 21 face each other. The cleaner 15 (see FIG. 1) removes toner that remains on the photoconductor drum 11 after the transfer process has been finished.

Forming of an electrostatic latent image and developing and transfer of a toner image are repeated for the second and third colors (for example, magenta and cyan) and the last color (for example, black) in the same manner as described above. When forming a toner image of each color, the rotary developing device 14 rotates, and the corresponding one of the developing units 14M and 14C is located at the stop position.

Meanwhile, the sheet S is rotated and transported while being wrapped around the transfer drum 21 and held by the leading end gripper 22 and the trailing end gripper 23, and toner images of the second to last colors are successively multi-transferred every time the sheet S passes the transfer region Tr. As a result, when forming, for example, a full-color image, toner images of yellow (Y), magenta (M), and cyan (C) (excluding black (K)) are multi-transferred to the sheet S on the transfer drum 21.

When transferring an image of the last color (for example black), in contrast to the cases of other colors, the leading end gripper 22 releases the sheet S in the transfer region Tr. That is, the state of the leading end gripper 22 changes from the closed state to the open state (see arrow h in FIG. 11). Moreover, the leading end gripper 22 releases the sheet S, on which a full-color image has been formed, and the sheet S is removed from the transfer drum 21 due to the nip between the elastic layer 21B and the photoconductor drum 11, and the sheet S enters the sheet output path 64.

Subsequently, as the sheet S is transported, the trailing end gripper 23, which holds the trailing end of the sheet S in the transport direction, reaches the standby position described above. For example, rotation of the rotary member motor 236 is controlled on the basis of a detection signal of a sensor (not shown) for detecting the position of the sheet restraining portion 231 of the trailing end gripper 23, and thereby the trailing end gripper 23 reaches the standby position. When the trailing end gripper is at the standby position, the lug portion 290 (see FIG. 7) comes into contact with the actuation tab 280 and pushes the actuation tab 280, and thereby the state of the trailing end gripper 23 changes from the stretched state to the relaxed state. In the relaxed state, the trailing end gripper 23 does not rotate together with the transfer drum 21, and the peripheral velocity becomes zero (see arrow in FIG. 11).

When the state of the trailing end gripper 23 changes from the stretched state to the relaxed state, the exposure device 13 has formed an electrostatic latent image of the last color (for example, black) in accordance with image information.

The trailing end of the sheet S in the transport direction, which is not being held by the trailing end gripper 23, is separated from the transfer drum 21 and enters the sheet output path 64. The sheet S is transported along the sheet output path 64 to the fixing section 40 in which a toner image is fixed to the sheet S. After fixing of the toner image has been finished, the sheet S is output to the outside of the image forming apparatus 1 by transport rollers 44 and stacked on the sheet stacker 3.

As described above, when the image forming apparatus 1 according to the present exemplary embodiment is in a multicolor mode, the controller 100 controls the trailing end gripper 23 so that the trailing end gripper 23 holds the trailing end of the sheet S, which has been picked up by the pick-up roller 52 and being transported along the sheet feeding path 61, in the transport direction and restrains the trailing end of the sheet S in the transport direction from rising on the basis of a detection signal sent from the first sheet detection sensor 55. That is, the controller 100 controls the rotary member motor 236, which rotates the rotary member 232 of the trailing end gripper 23, so that the tailing end portion, in the transport direction, of the sheet S that has been actually supplied to the transfer drum 21 and the sheet restraining portion 231 of the trailing end gripper 23 face each other. Because the sheet restraining portion 231 of the trailing end gripper 23 according to the present exemplary embodiment is located at the standby position between the sheet feeding position Pa and the transfer region Tr, the trailing end portion of the sheet S in the transport direction and the sheet restraining portion 231 are easily made to face each other.

Thus, even if the length of a sheet on which an image is to be formed (hereinafter referred to as a “set sheet length”), which has been calculated on the basis of a signal from the user interface 60 or a signal from the image output instruction unit 90, is different from the length of the sheet S that has been actually transported, the trailing end gripper 23 restrains the trailing end portion of the sheet S that has been actually transported from rising.

With the image forming apparatus 1 according to the present exemplary embodiment, if there is an error between the set sheet length and the length of the actually transported sheet S, the controller 100 detects the error, changes the setting of the length of the sheet S, and changes the position at which forming of a toner image is finished.

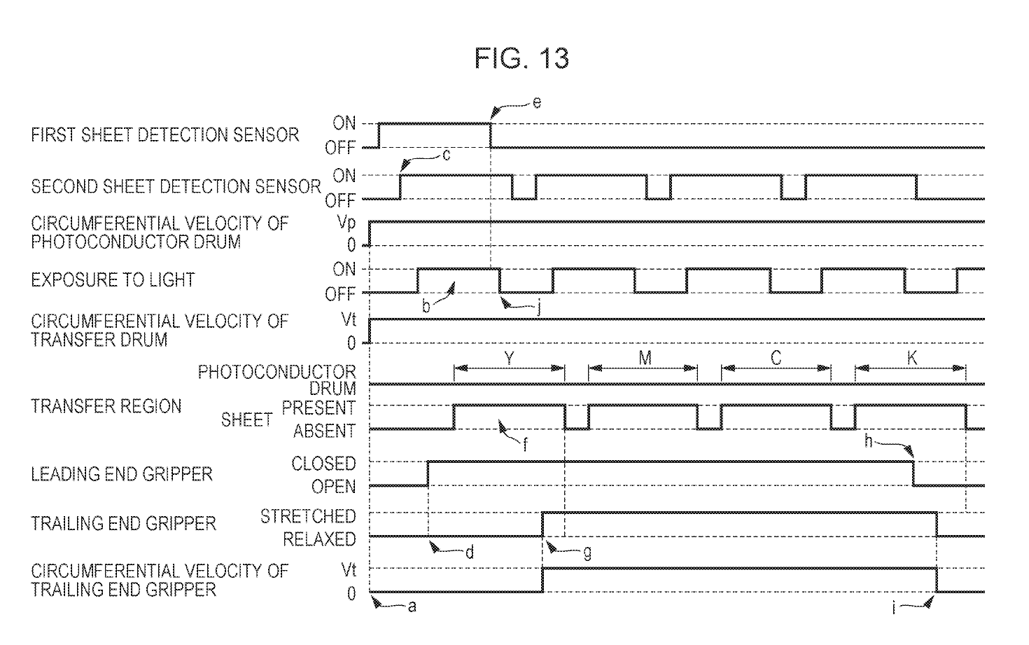

FIG. 13 is a timing chart of an operation with which an error between the set sheet length and the length of an actually transported sheet S is obtained and then the setting of the position at which forming of a toner image on the photoconductor drum 11 is finished is changed.

When the controller 100 detects passing of the trailing end of the sheet S in the transport direction on the basis of a detection signal of the first sheet detection sensor 55 (see arrow e), and if there is an error between the set sheet length and the length of the actually transported sheet S, the controller 100 changes the position at which the exposure device 13 finishes forming of an electrostatic latent image (see arrow j).

Next, in the image forming apparatus 1 configured as described above, how the trailing end gripper 23 restrains the trailing end portion of the sheet S in the transport direction from rising will be described in detail.

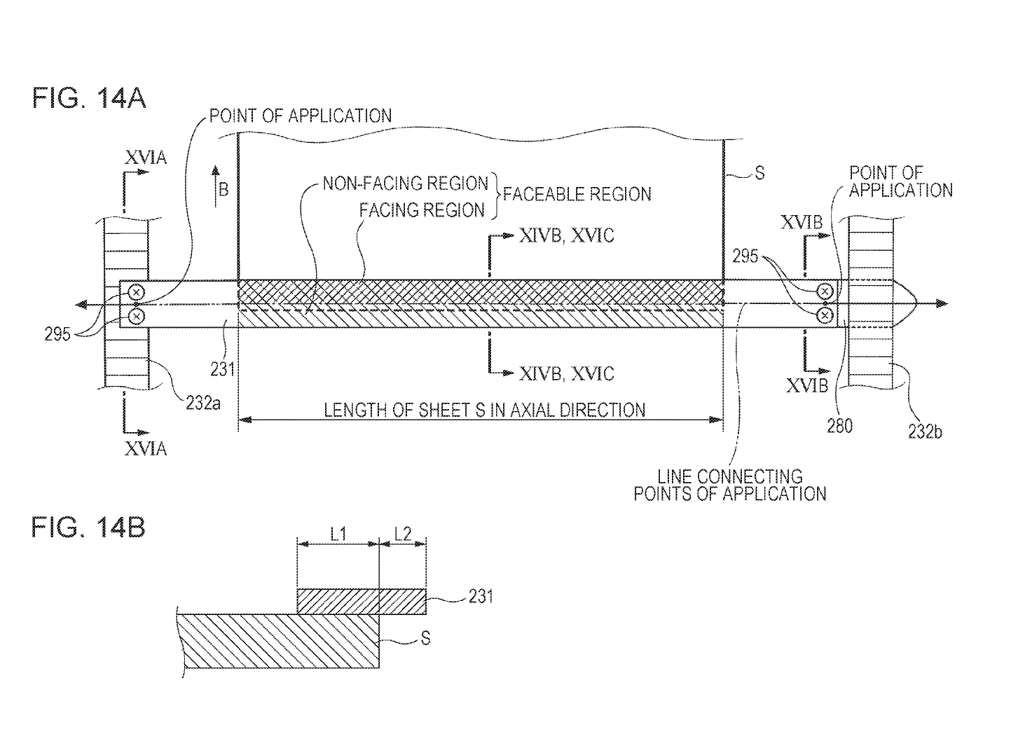

FIG. 14A is a schematic view illustrating the relative positions of the trailing end portion of a sheet S in the transport direction and the sheet restraining portion 231 of the trailing end gripper 23. FIG. 14B is a sectional view taken along line XIVB-XIVB of FIG. 14A.

After receiving a signal indicating detection of the trailing end of a sheet from the first sheet detection sensor 55, the controller 100 drives the rotary member motor 236 so as to make the trailing end portion of the sheet S in the transport direction and the sheet restraining portion 231 face each other. At this time, the controller 100 makes a part of a region of the sheet restraining portion 231 that is faceable with the sheet S and that is facing the sheet S be larger than a part of the region that is not facing the sheet S.

That is, as illustrated in FIG. 14B, the controller 100 causes the sheet restraining portion 231 to face the trailing end of the sheet S in the transport direction such that a length L1, over which the trailing end of the sheet S in the transport direction faces the sheet restraining portion 231, is larger than a length L2, over which the trailing end portion of the sheet S in the transport direction does not face the sheet restraining portion 231. Here, in the image forming apparatus 1 according to the present exemplary embodiment, the sheet restraining portion 231 is disposed so as to extend in the rotational axis direction, and the lengths L1 and L2 of the sheet restraining portion 231 are the lengths with respect to the transport direction of the sheet S. Thus, the trailing end portion of the sheet S is more firmly pressed even if the trailing end portion of the sheet S in the transport direction is likely to rise from the outer peripheral surface of the transfer drum 21 or the sheet S rises due to the presence of a gap between the sheet S and the sheet restraining portion 231. Therefore, even if the thickness of the sheet restraining portion 231 is small, the sheet restraining portion 231 is capable of reliably restraining the trailing end of the sheet S in the transport direction from rising.

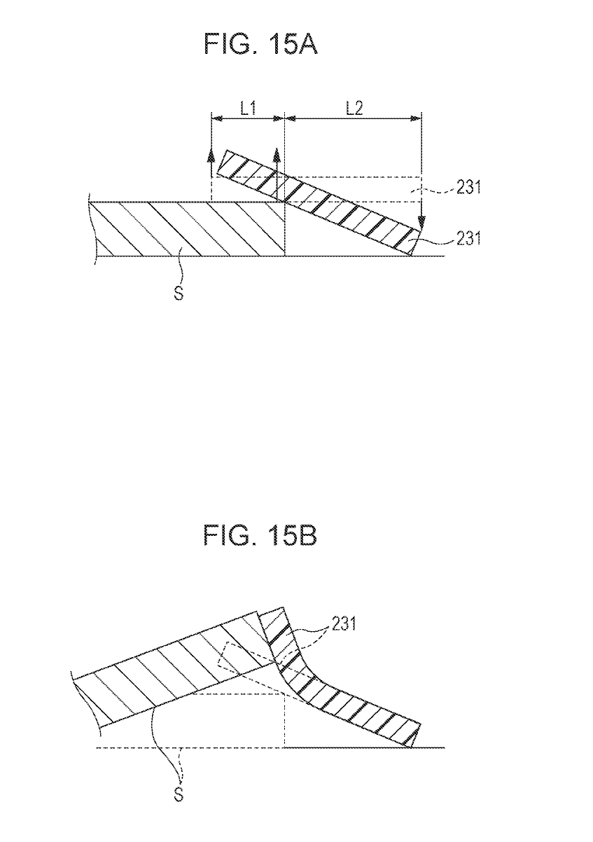

FIGS. 15A and 15B illustrate an example of a fault that may occur if a part a region of the sheet restraining portion 231 that is faceable with the sheet S and that is facing the trailing end portion of the sheet S is smaller than a part of the region that is not facing the trailing end portion of the sheet S.

The sheet restraining portion 231 may be unable to resist a force with which the trailing end portion of the sheet S in the transport direction rises from the outer peripheral surface of the transfer drum 21 if a part a region of the sheet restraining portion 231 that is faceable with the sheet S and that is facing the sheet S is smaller than a part of the region that is not facing the sheet S, that is, as illustrated in FIG. 15A, if the length L1, over which the trailing end of the sheet S in the transport direction faces the sheet restraining portion 231, is smaller than the length L2, over which the trailing end of the sheet S in the transport direction does not face the sheet restraining portion 231. In such a case, the sheet restraining portion 231 may be rotated by a force applied from the trailing end portion of the sheet S as illustrated in FIG. 15A and may cause the trailing end of the sheet S in the transport direction to rise from the outer peripheral surface of the transfer drum 21 as illustrated in FIG. 15B. As a result, the sheet S, on which an unfixed toner image has been formed, may be transported along the rotation path 63 while the trailing end portion of the sheet S is separated from the outer peripheral surface of the transfer drum 21, and the phase sensor 24 and the second sheet detection sensor 56, which are disposed around the transfer drum 21, may be smudged due to the unfixed toner image, and thereby a detection failure may occur. Moreover, the unfixed toner image, which has been transferred to the sheet S, may come off or may be smeared, and an image failure may occur.

In the present exemplary embodiment, the first end of the sheet restraining portion 231 in the rotational axis direction is screwed to the first rotary member 232a with the pair of screws 295 that are arranged in a direction perpendicular to the rotational axis direction. The second end of the sheet restraining portion 231 in the rotational axis direction is screwed to the actuation tab 280 with the pair of screws 295 that are arranged in a direction perpendicular to the rotational axis direction. When the trailing end gripper 23 is in the stretched state, the actuation tab 280 is urged by the spring member (not shown) in the rotational axis direction from a middle portion toward an end portion (direction of arrow H1 in FIG. 8). Therefore, when the trailing end gripper 23 is in the stretched state, a resultant force (tensile force) in the rotational axis direction is applied to a midpoint between each pair of screws 295 at ends of the sheet restraining portion 231 in the rotational axis direction. With the image forming apparatus 1 according to the present exemplary embodiment, the controller 100 causes the sheet restraining portion 231 to face the trailing end of the sheet S such that a line connecting the points of application of the two resultant forces passes a region in which the sheet restraining portion 231 faces the trailing end portion of the sheet S in the transport direction.

Thus, the trailing end portion of the sheet S is more firmly pressed even if the trailing end of the sheet S in the transport direction is likely to rise from the outer peripheral surface of the transfer drum 21 or the sheet S rises due to the presence of a gap between the sheet S and the sheet restraining portion 231. Therefore, the sheet restraining portion 231 having a small thickness is capable of reliably restraining the trailing end of the sheet S in the transport direction from rising.

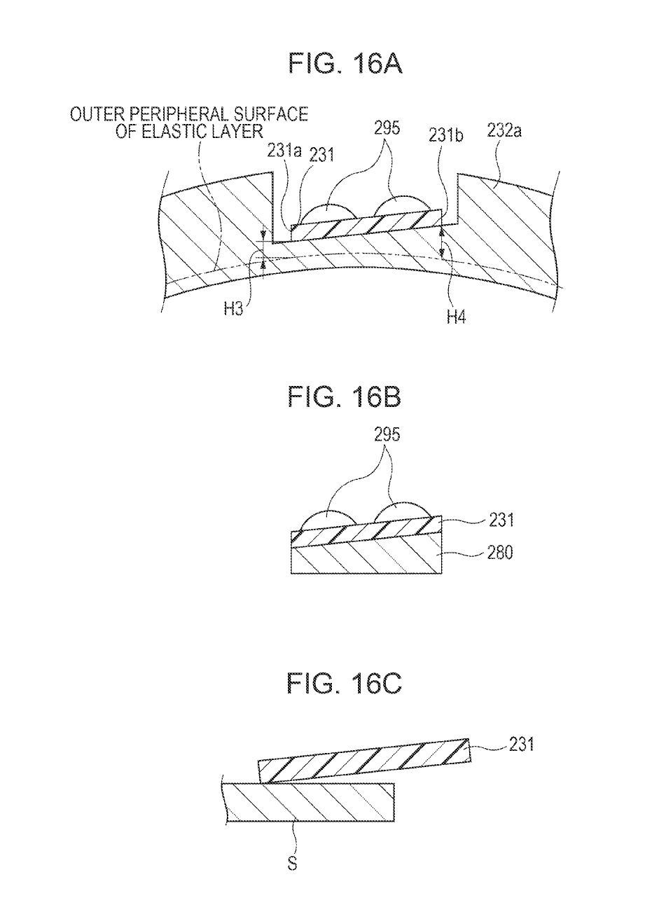

FIGS. 16A to 16C are schematic sectional views of a sheet restraining portion 231 according to another exemplary embodiment. FIG. 16A is a sectional view taken along line XVIA-XVIA of FIG. 14A. FIG. 16B is a sectional view taken along line XVIB-XVIB of FIG. 14A. FIG. 16C is a sectional view taken along line XVIC-XVIC of FIG. 14A.

In the exemplary embodiment described above, the sheet restraining portion 231 has a width in the transport direction of the sheet S. However, this is not necessarily the case. For example, the sheet restraining portion 231, which is rectangular-parallelepiped-shaped as described above, may be disposed so that the distance H3 between a leading end portion 231a in the transport direction of the sheet S and the outer peripheral surface of the elastic layer 21B of the transfer drum 21 is smaller than the distance H4 between a trailing end portion 231b in the transport direction and the outer peripheral surface of the elastic layer 21B. With this structure, the sheet restraining portion 231 more firmly presses the trailing end portion of the sheet S in the transport direction with a smaller force. Therefore, even if the thickness of the sheet restraining portion 231 is small, the trailing end of the sheet S in the transport direction is more reliably restrained from rising.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that is rotatably disposed and that carries an image on an outer peripheral surface thereof;
a transfer member that is rotatably disposed such that an outer peripheral surface thereof faces the outer peripheral surface of the image carrier, the transfer member transferring the image carried on the image carrier to a recording medium in a transfer region that is formed by the transfer member and the image carrier;
a gripper that rotates in synchronism with the transfer member, the gripper gripping a leading end portion, in a transport direction, of the recording medium that is transported toward the transfer region; and
a restraining portion that is disposed so as to face the outer peripheral surface of the transfer member and that is movable relative to the transfer member, the restraining member restraining a trailing end portion, in the transport direction, of the recording medium that is gripped by the gripper from rising,
wherein the restraining portion has a width in a rotational axis direction of the transfer member and a width in the transport direction of the recording medium and is capable of facing the recording medium in a faceable region, and a part of the faceable region over which the restraining portion faces the trailing end portion, in the transport direction, of the recording medium is larger than a part of the faceable region over which the restraining member does not face the trailing end portion, in the transport direction, of the recording medium.

2. The image forming apparatus according to claim 1,
wherein a length, in the transport direction, of the restraining portion over which the restraining portion faces the trailing end portion, in the transport direction, of the recording medium is larger than a length of the restraining portion over which the restraining portion does face the trailing end, in the transport direction, of the recording medium.

3. The image forming apparatus according to claim 1,
wherein the restraining portion faces the trailing end portion, in the transport direction, of the recording medium in a state in which the restraining portion is pulled and stretched in the rotational axis direction.

4. The image forming apparatus according to claim 2,
wherein the restraining portion faces the trailing end portion, in the transport direction, of the recording medium in a state in which the restraining portion is pulled and stretched in the rotational axis direction.

5. The image forming apparatus according to claim 3,
wherein the restraining portion has a point of application at each of ends thereof in the rotational axis direction to which a tensile force that pulls the restraining portion is applied, and a line that passes the points of application passes the part of the faceable region over which the restraining portion faces the trailing end portion, in the transport direction, of the recording medium.

6. The image forming apparatus according to claim 4,
wherein the restraining portion has a point of application at each of ends thereof in the rotational axis direction to which a tensile force that pulls the restraining portion is applied, and a line that passes the points of application passes the part of the faceable region over which the restraining portion faces the trailing end portion, in the transport direction, of the recording medium.

7. The image forming apparatus according to claim 1,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.

8. The image forming apparatus according to claim 2,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.

9. The image forming apparatus according to claim 3,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.

10. The image forming apparatus according to claim 4,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.

11. The image forming apparatus according to claims 5,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.

12. The image forming apparatus according to claim 6,
wherein a distance between an end, in the transport direction, of the restraining portion and the outer peripheral surface the transfer member is smaller than a distance between an end, in a direction opposite to the transport direction, of the restraining portion and the outer peripheral surface the transfer member.
